(19) United States
(12) Patent Application Publication
(10) Pub. No.: US 2026/0095235 A1
(43) Pub. Date: Apr. 2, 2026

(54) RESOURCE INDICATION

(71) Applicant: Huawei Technologies Co., Ltd., Shenzhen (CN)

(72) Inventors: Hao Tang, Ottawa (CA); Jianglei Ma, Ottawa (CA); Wen Tong, Ottawa (CA); Liqing Zhang, Ottawa (CA)

(21) Appl. No.: 19/411,166

(22) Filed: Dec. 5, 2025

Related U.S. Application Data
(63) Continuation of application No. PCT/CN2023/115663, filed on Aug. 30, 2023.
(60) Provisional application No. 63/506,865, filed on Jun. 8, 2023.

(51) Int. Cl. H04B 7/06; H04L 5/14; H04W 72/044

(52) U.S. Cl. CPC H04B 7/06968; H04L 5/14; H04W 72/044

(57) ABSTRACT

Example embodiments of the present disclosure relate to resource indication. In an example method, a terminal device receives a first indication of first one or more resources for transmission. The first indication comprises at least three of first time domain information, first frequency domain information, first spatial domain information, or first power domain information of the first one or more resources.

### CROSS-REFERENCE TO RELATED APPLICATIONS

This application is a continuation of International Application No. PCT/CN2023/115663, filed on Aug. 30, 2023, which claims priority to U.S. Provisional Patent Application No. 63/506,865, filed on Jun. 8, 2023, both of which are hereby incorporated by reference in their entireties.

### TECHNICAL FIELD

Example embodiments of the present disclosure generally relate to the field of communications, and in particular, to resource indication, for example, a unified and duplex 3D resource indication.

### BACKGROUND

In current NR network, there are three-level frame structure configurations for time division duplex (TDD), which are very complicated. A slot format includes downlink symbols, uplink symbols, and flexible symbols. The three-level frame structure configurations for TDD include semi-statically configured cell common/cell specific slot configuration, such as tdd-UL-DL-ConfigurationCommon in ServingCellConfigCommon or ServingCellConfigCommonSIB, semi-statically configured UE-specific dedicated slot configuration, such as tdd-UL-DL-ConfigurationDedicated in ServingCellConfig, and UE-/UE group-specific dynamic configuration or indication, such as SlotFormatIndicator, sfi-RNTI and a payload size of DCI format 2_0 by dci-PayloadSize. These configuration parameters are provided by a higher-layer signaling such as RRC signaling and indicated by the physical layer signaling or dynamic signaling such as downlink control information (DCI). In addition, NR supports multiple duplex methods: FDD, TDD, Full Duplex and Subband non-overlapping full duplex (SBFD). For different duplex methods, different frame structure configuration methods are used. Generally speaking, current scheme can be regarded as 2D spectrum utilization: time-domain and frequency-domain, e.g. in which symbols and BWP/carrier for UE reception or transmission.

In 6G, a unified spectrum utilization should be designed for multiple duplex schemes, including FDD, TDD, Full duplex, Subband non-overlapping full duplex (SBFD). However, beam-specific transmission direction (reception (Rx) or transmission (Tx)) indication is not taken into consideration in NR, and spectrum utilization schemes in NR are complicated and non-unified.

### SUMMARY

In general, example embodiments of the present disclosure provide a solution for a resource indication, for example, a unified and duplex 3D resource indication. In particular, a beam/MIMO layer dependent Rx/Tx configuration is proposed, in which 3D/4D (time-frequency-spatial domain, optionally, power domain) spectrum resource indication is utilized.

In a first aspect, there is provided a method. The method comprises: receiving, by a terminal device, a first indication of first one or more resources for transmission, wherein the first indication comprises at least three of first time domain information, first frequency domain information, first spatial domain information, or first power domain information of the first one or more resources. In this way, unified spectrum utilization can be designed for full duplex, SBFD, TDD and FDD via beam-specific transmission direction indication.

In some example embodiments, the method further comprises: receiving, by the terminal device, a second indication of second one or more resources for reception, wherein the second indication comprises at least three of second time domain information, second frequency domain information, second spatial domain information, or second power domain information of the second one or more resources. In this way, unified spectrum utilization can be designed for full duplex, SBFD, TDD and FDD via beam-specific transmission direction indication.

In some example embodiments, the first time domain information and the second time domain information are the same or different. In addition or as an alternative, the first frequency domain information and the second frequency domain information are the same or different. In addition or as an alternative, the first spatial domain information and the second spatial domain information are the same or different. In this way, unified spectrum utilization can be designed for full duplex, SBFD, TDD and FDD via beam-specific transmission direction indication.

In some example embodiments, the first time domain information and the second time domain information are the same, the first frequency domain information and the second frequency domain information are the same, and the first spatial domain information and the second spatial domain information are different. In this way, the terminal device can achieve full duplex in time domain and frequency domain, and the resource efficiency can be improved.

In some example embodiments, the first spatial domain information indicates at least one beam in a UL beam set, and the second spatial domain information indicates at least one beam in a DL beam set. In this way, unified spectrum utilization can be designed for full duplex, SBFD, TDD and FDD via beam-specific transmission direction indication.

In some example embodiments, the first spatial domain information indicates a first beam in the UL beam set, and a second beam in the UL beam set, and the first time domain information comprises time domain information for the first beam and time domain information for the second beam which are the same or different. In this way, the terminal device can achieve full duplex in time domain and frequency domain, and the resource efficiency can be improved.

In some example embodiments, the second spatial domain information indicates a third beam in the DL beam set, and a fourth beam in the DL beam set, and the second time domain information comprises time domain information for the third beam and time domain information for the fourth beam which are the same or different. In this way, the terminal device can achieve full duplex in time domain and frequency domain, and the resource efficiency can be improved.

In some example embodiments, the first spatial domain information indicates a first beam in the UL beam set, and a second beam in the UL beam set, and the first power domain information comprises power domain information for the first beam and power domain information for the second beam which are the same or different. In this way, unified spectrum utilization can be designed for full duplex, SBFD, TDD and FDD via beam-specific transmission direction indication and power control parameter indication.

In some example embodiments, the second spatial domain information indicates a third beam in the DL beam set, and a fourth beam in the DL beam set, and the second power domain information comprises power domain information for the third beam and power domain information for the fourth beam which are the same or different. In this way, unified spectrum utilization can be designed for full duplex, SBFD, TDD and FDD via beam-specific transmission direction indication and power control parameter indication.

In some example embodiments, the first indication is indicative of a first beam which is a UL beam, and the method further comprises: receiving, from the network device, information indicating that a second signal associated with a second beam is quasi co-located (QCLed) with a first signal associated with the first beam with regard to a quasi co-location (QCL) type, wherein the second beam is a DL beam, and the quasi co-location (QCL) type indicates that transmission of the first signal via the first beam and reception of the second signal via the second beam are performed simultaneously. In this way, unified spectrum utilization can be designed for full duplex, SBFD, TDD and FDD via beam-specific transmission direction indication by a newly defined QCL type.

In some example embodiments, the first indication is indicative of a first frame structure for the first beam, and the method further comprises: based on determining that the second signal associated with the second beam is QCLed with the first signal associated with the first beam with regard to the QCL type, determining a second frame structure for the second beam based on the first frame structure for the first beam, without receiving the second frame structure from the network device. In this way, unified spectrum utilization can be designed for full duplex, SBFD, TDD and FDD via beam-specific transmission direction indication by a newly defined QCL type.

In some example embodiments, the first indication is indicative of a first resource and a second resource; the time domain information comprises first time domain information for the first resource and second time domain information for the second resource, and the first time domain information and the second time domain information are the same or different; the frequency domain information comprises first frequency domain information for the first resource and second frequency domain information for the second resource, and the first frequency time domain information and the second frequency domain information are the same or different; and the spatial domain information comprises first spatial domain information for the first resource and second spatial domain information for the second resource, and the first spatial domain information and the second spatial domain information are the same or different. In this way, unified spectrum utilization can be designed for full duplex, SBFD, TDD and FDD via beam-specific transmission direction indication.

In some example embodiments, the first spatial domain information is indicative of a beam; and the first time domain information is indicative of a set of symbols for the beam, wherein the set of symbols includes at least one UL symbol. In this way, unified spectrum utilization can be designed for full duplex, SBFD, TDD and FDD via beam-specific transmission direction indication.

In some example embodiments, the second spatial domain information is indicative of a beam; and the second time domain information is indicative of a set of symbols for the beam, wherein the set of symbols includes at least one DL symbol. In this way, unified spectrum utilization can be designed for full duplex, SBFD, TDD and FDD via beam-specific transmission direction indication.

In some example embodiments, the first indication comprises: the first time domain information; the first frequency domain information; and the first spatial domain information. In this way, unified spectrum utilization can be designed for full duplex, SBFD, TDD and FDD via beam-specific transmission direction indication.

In some example embodiments, the first indication further comprises the first power domain information. In this way, unified spectrum utilization can be designed for full duplex, SBFD, TDD and FDD via beam-specific transmission direction indication and power control parameter indication.

In some example embodiments, the first time domain information indicates at least one of the following of the one or more resources: a symbol location; a slot location; or a subframe location. In this way, unified spectrum utilization can be designed for full duplex, SBFD, TDD and FDD via beam-specific transmission direction indication.

In some example embodiments, the first frequency domain information indicates at least one of the following of the one or more resources: carrier information; bandwidth part (BWP) information; or resource block (RB) information. In this way, unified spectrum utilization can be designed for full duplex, SBFD, TDD and FDD via beam-specific transmission direction indication.

In some example embodiments, the first spatial domain information indicates at least one of the following of the one or more resources: a beam index; a beam set; or multiple-input multiple-output (MIMO) layer information. In this way, unified spectrum utilization can be designed for full duplex, SBFD, TDD and FDD via beam-specific transmission direction indication.

In some example embodiments, the first power domain information indicates at least one power control parameter of the first one or more resources, and the second power domain information indicates at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information comprise at least one of the following: configured maximum output power in the associated beam, expected receiving power at the receiver node, or a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device is represented by at least one channel state information (CSI)-reference signal (RS) resource; or the first spatial domain information of the first one or more resources for transmission by the terminal device is represented by at least one sounding reference signal (SRS) resource. In this way, unified spectrum utilization can be designed for full duplex, SBFD, TDD and FDD via beam-specific transmission direction indication.

In this way, according to the first aspect and its example embodiments, unified spectrum utilization can be designed for full duplex, SBFD, TDD and FDD via beam-specific transmission direction indication.

In a second aspect, there is provided a method. The method comprises: determining, at a network device, first one or more resources for a terminal device to perform transmission; and transmitting, to the terminal device, a first indication of the first one or more resources, wherein the first indication comprises at least three of first time domain information, first frequency domain information, first spatial domain information, or first power domain information of the first one or more resources. In this way, unified spectrum utilization can be designed for full duplex, SBFD, TDD and FDD via beam-specific transmission direction indication.

In some example embodiments, the method further comprises: determining, at the network device, second one or more resources for the terminal device to perform reception; and transmitting, to the terminal device, a second indication of the second one or more resources, wherein the second indication comprises at least three of second time domain information, second frequency domain information, second spatial domain information, or second power domain information of the second one or more resources. In this way, unified spectrum utilization can be designed for full duplex, SBFD, TDD and FDD via beam-specific transmission direction indication.

In some example embodiments, at least one of the following: the first time domain information and the second time domain information are the same or different; the first frequency domain information and the second frequency domain information are the same or different; or the first spatial domain information and the second spatial domain information are the same or different. In this way, unified spectrum utilization can be designed for full duplex, SBFD, TDD and FDD via beam-specific transmission direction indication.

In some example embodiments, the first time domain information and the second time domain information are the same, the first frequency domain information and the second frequency domain information are the same, and the first spatial domain information and the second spatial domain information are different. In this way, the terminal device can achieve full duplex in time domain and frequency domain, and the resource efficiency can be improved.

In some example embodiments, the first spatial domain information indicates at least one beam in a UL beam set, and the second spatial domain information indicates at least one beam in a DL beam set. In this way, unified spectrum utilization can be designed for full duplex, SBFD, TDD and FDD via beam-specific transmission direction indication.

In some example embodiments, the first spatial domain information indicates a first beam in the UL beam set, and a second beam in the UL beam set, and the first time domain information comprises time domain information for the first beam and time domain information for the second beam which are the same or different. In this way, the terminal device can achieve full duplex in time domain and frequency domain, and the resource efficiency can be improved.

In some example embodiments, the second spatial domain information indicates a third beam in the DL beam set, and a fourth beam in the DL beam set, and the second time domain information comprises time domain information for the third beam and time domain information for the fourth beam which are the same or different. In this way, the terminal device can achieve full duplex in time domain and frequency domain, and the resource efficiency can be improved.

In some example embodiments, the first spatial domain information indicates a first beam in the UL beam set, and a second beam in the UL beam set, and the first power domain information comprises power domain information for the first beam and power domain information for the second beam which are the same or different. In this way, unified spectrum utilization can be designed for full duplex, SBFD, TDD and FDD via beam-specific transmission direction indication and power control parameter indication.

In some example embodiments, the second spatial domain information indicates a third beam in the DL beam set, and a fourth beam in the DL beam set, and the second power domain information comprises power domain information for the third beam and power domain information for the fourth beam which are the same or different. In this way, unified spectrum utilization can be designed for full duplex, SBFD, TDD and FDD via beam-specific transmission direction indication and power control parameter indication.

In some example embodiments, the first indication is indicative of a first beam which is a UL beam, and the method further comprises: determining that transmission of a first signal via the first beam and reception of a second signal via a second beam are to be performed simultaneously, wherein the second beam is a DL beam; and transmitting, to the terminal device, information indicating that the second signal associated with the second beam is quasi co-located (QCLed) with the first signal associated with the first beam with regard to a quasi co-location (QCL) type, and the quasi co-location (QCL) type indicates that transmission of the first signal via the first beam and reception of the second signal via the second beam are performed simultaneously at the terminal device. In this way, unified spectrum utilization can be designed for full duplex, SBFD, TDD and FDD via beam-specific transmission direction indication by a newly defined QCL type.

In some example embodiments, the first indication is indicative of a first frame structure for the first beam, and the method further comprises: preventing from transmitting, to the terminal device, a second frame structure for the second beam. In this way, unified spectrum utilization can be designed for full duplex, SBFD, TDD and FDD via beam-specific transmission direction indication by a newly defined QCL type, and frame structure can be indicated to the terminal device in an implicit way, i.e., without explicit signaling. Therefore, overhead can be reduced.

In some example embodiments, the first indication is indicative of a first resource and a second resource; the time domain information comprises first time domain information for the first resource and second time domain information for the second resource, and the first time domain information and the second time domain information are the same or different; the frequency domain information comprises first frequency domain information for the first resource and second frequency domain information for the second resource, and the first frequency time domain information and the second frequency domain information are the same or different; and the spatial domain information comprises first spatial domain information for the first resource and second spatial domain information for the second resource, and the first spatial domain information and the second spatial domain information are the same or different. In this way, unified spectrum utilization can be designed for full duplex, SBFD, TDD and FDD via beam-specific transmission direction indication.

In some example embodiments, the first spatial domain information is indicative of a beam; and the first time domain information is indicative of a set of symbols for the beam, wherein the set of symbols includes at least one UL symbol. In this way, unified spectrum utilization can be designed for full duplex, SBFD, TDD and FDD via beam-specific transmission direction indication.

In some example embodiments, the second spatial domain information is indicative of a beam; and the second time domain information is indicative of a set of symbols for the beam, wherein the set of symbols includes at least one DL symbol. In this way, unified spectrum utilization can be designed for full duplex, SBFD, TDD and FDD via beam-specific transmission direction indication.

In some example embodiments, the first indication comprises: the first time domain information; the first frequency domain information; and the first spatial domain information. In this way, unified spectrum utilization can be designed for full duplex, SBFD, TDD and FDD via beam-specific transmission direction indication.

In some example embodiments, the first indication further comprises the first power domain information. In this way, unified spectrum utilization can be designed for full duplex, SBFD, TDD and FDD via beam-specific transmission direction indication and power control parameter indication.

In some example embodiments, the first time domain information indicates at least one of the following of the one or more resources: a symbol location; a slot location, or a subframe location. In this way, unified spectrum utilization can be designed for full duplex, SBFD, TDD and FDD via beam-specific transmission direction indication.

In some example embodiments, the first frequency domain information indicates at least one of the following of the one or more resources: carrier information; bandwidth part (BWP) information; or resource block (RB) information. In this way, unified spectrum utilization can be designed for full duplex, SBFD, TDD and FDD via beam-specific transmission direction indication.

In some example embodiments, the first spatial domain information indicates at least one of the following of the one or more resources: a beam index; a beam set; or multiple-input multiple-output (MIMO) layer information. In this way, unified spectrum utilization can be designed for full duplex, SBFD, TDD and FDD via beam-specific transmission direction indication.

In some example embodiments, the first power domain information indicates at least one power control parameter of the first one or more resources, and the second power domain information indicates at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information comprise at least one of the following: configured maximum output power in the associated beam, expected receiving power at the receiver node, or a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device is represented by at least one channel state information (CSI)-reference signal (RS) resource; or the first spatial domain information of the first one or more resources for transmission by the terminal device is represented by at least one sounding reference signal (SRS) resource. In this way, unified spectrum utilization can be designed for full duplex, SBFD, TDD and FDD via beam-specific transmission direction indication.

In this way, according to the second aspect and its example embodiments, unified spectrum utilization can be designed for full duplex, SBFD, TDD and FDD via beam-specific transmission direction indication.

In a third aspect, there is provided a terminal device. The terminal device comprises: a transceiver; and a processor communicatively coupled with the transceiver, wherein the processor is configured to: receive, via the transceiver, a first indication of first one or more resources for transmission, wherein the first indication comprises at least three of first time domain information, first frequency domain information, first spatial domain information, or first power domain information of the first one or more resources. In this way, unified spectrum utilization can be designed for full duplex, SBFD, TDD and FDD via beam-specific transmission direction indication.

In a fourth aspect, there is provided a network device. The network device comprises: a transceiver; and a processor communicatively coupled with the transceiver, wherein the processor is configured to: determine first one or more resources for a terminal device to perform transmission; and transmit, via the transceiver and to the terminal device, a first indication of the first one or more resources and a second indication of the second one or more resources, wherein the first indication comprises at least three of first time domain information, first frequency domain information, first spatial domain information, or first power domain information of the first one or more resources. In this way, unified spectrum utilization can be designed for full duplex, SBFD, TDD and FDD via beam-specific transmission direction indication.

In a fifth aspect, there is provided a non-transitory computer-readable storage medium comprising computer program stored thereon. The computer program, when executed on at least one processor, cause the at least one processor to perform the method of any of the first or second aspects. In this way, unified spectrum utilization can be designed for full duplex, SBFD, TDD and FDD via beam-specific transmission direction indication.

In a sixth aspect, there is provided a chip comprising at least one processing circuit configured to perform the method of any the first or second aspect. In this way, unified spectrum utilization can be designed for full duplex, SBFD, TDD and FDD via beam-specific transmission direction indication.

In a seventh aspect, there is provided a computer program product tangibly stored on a computer-readable medium and comprising computer-executable instructions which, when executed, cause an apparatus to perform a method of any of the first or second aspect. In this way, unified spectrum utilization can be designed for full duplex, SBFD, TDD and FDD via beam-specific transmission direction indication.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates an example communication system 100B in which some example embodiments of the present disclosure may be implemented;

FIG. 1C illustrates an example of an electric device and a base station in accordance with some example embodiments of the present disclosure;

FIG. 1D illustrates units or modules in a device in accordance with some example embodiments of the present disclosure;

FIG. 2 illustrates a signaling chart illustrating an example communication process in accordance with some example embodiments of the present disclosure;

FIG. 3A illustrates a schematic diagram of an example full duplex by beam isolation in accordance with some embodiments of the present disclosure;

FIG. 3B illustrates a schematic diagram of an example frame structure in accordance with some embodiments of the present disclosure;

FIG. 3C illustrates a schematic diagram of another example frame structure in accordance with some embodiments of the present disclosure;

FIG. 4A illustrates a schematic diagram of an example QCL-type full duplex in accordance with some embodiments of the present disclosure;

FIG. 4B illustrates a schematic diagram of a further example frame structure in accordance with some embodiments of the present disclosure;

FIG. 5 illustrates a schematic diagram of a still further example frame structure in accordance with some embodiments of the present disclosure;

FIG. 6 illustrates a schematic diagram of a still further example frame structure in accordance with some embodiments of the present disclosure;

FIG. 7 illustrates a signaling chart illustrating another example communication process in accordance with some embodiments of the present disclosure;

FIG. 8 illustrates a signaling chart illustrating another example communication process in accordance with some embodiments of the present disclosure;

FIG. 9 illustrates a simplified block diagram of an apparatus according to some example embodiments of the present disclosure;

FIG. 10 illustrates a simplified block diagram of another apparatus according to some example embodiments of the present disclosure; and

FIG. 11 illustrates a simplified block diagram of a device that is suitable for implementing some example embodiments of the present disclosure.

Throughout the drawings, the same or similar reference numerals represent the same or similar elements.

### DETAILED DESCRIPTION OF THE ILLUSTRATIVE EMBODIMENTS

Principles of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a VR (virtual reality) device, an XR (extended reality) device, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

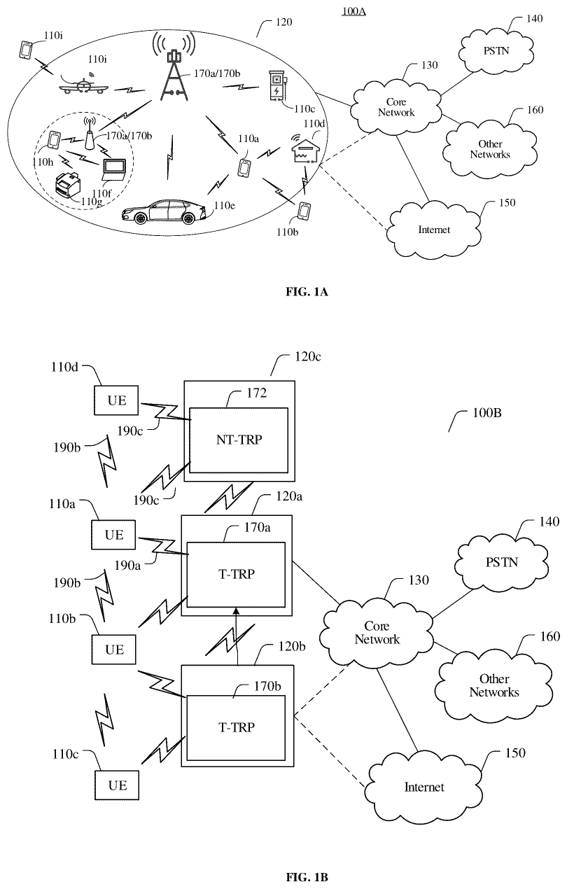

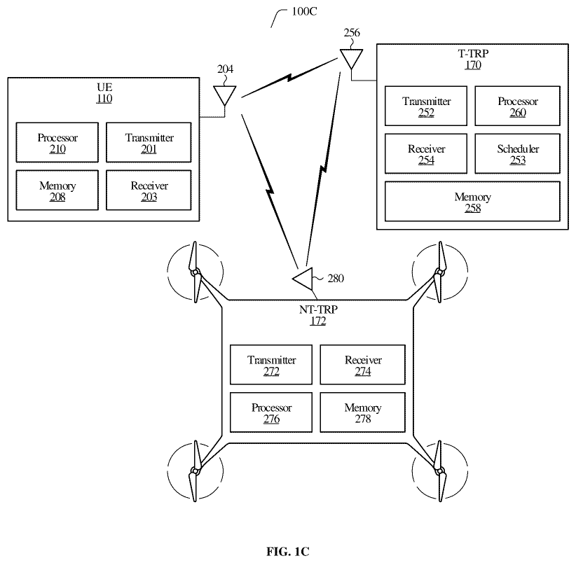

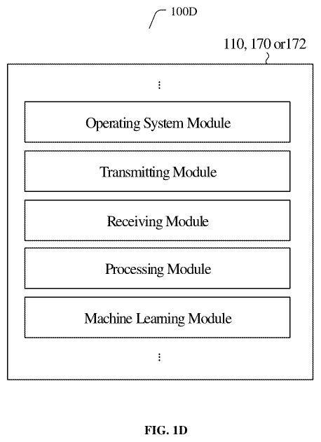

Referring to FIG. 1A, as an illustrative example without limitation, a simplified schematic illustration of a communication system is provided. The communication system 100A comprises a radio access network 120. The radio access network 120 may be a next generation (e.g. sixth generation (6G) or later) radio access network, or a legacy (e.g. 5G, 4G, 3G or 2G) radio access network. One or more communication user equipment (UE, also referred to as electric device (ED)) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160. The other networks 160 may include a multi-access edge computing (MEC) platform, which will be described later in more detail.

FIG. 1B illustrates an example communication system 100B. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172. As described above, the other networks 160 may include a multi-access edge computing (MEC) platform.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 1C illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

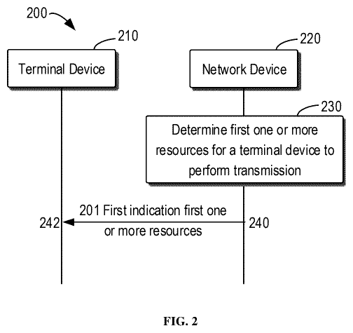

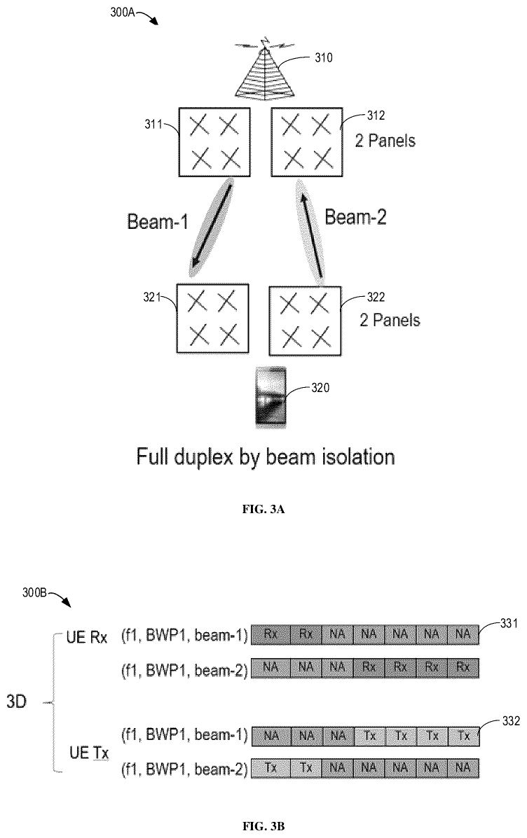

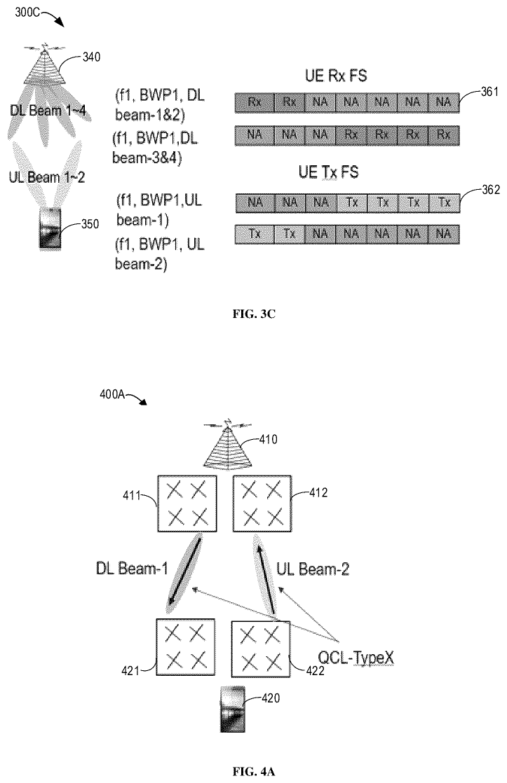

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 1D. FIG. 1D illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

6G intelligent air interface is now described. An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is now described. A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

Cell/Carrier/Bandwidth Parts (BWPs)/Occupied Bandwidth are now described in more detail. A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

Precoding as used herein may refer to any coding operation(s) or modulation(s) that transform a [ . . . ] input signal into a [ . . . ] output signal. Precoding may be performed in different domains, and typically transform the input signal in a first domain to an output signal in a second domain. Precoding may include linear operations.

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtain the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI)s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

### Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

### Federated Learning:

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure is performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface”. In some embodiments, there may be two types of AI operation in an AI enabled air interface: both the network and the UE implement learning; or learning is only applied by the network.

Network energy saving is of great importance for environmental sustainability, to reduce environmental impact, i.e. greenhouse gas emissions, and energy consumption has become a key part of the operators' OPEX. According to the report from GSMA, the energy cost on mobile networks accounts for ˜23% of the total operator cost. Most of the energy consumption comes from the radio access network, with data centers and fiber transport accounting for a smaller share.

In recent years, to meet people's increasing traffic requirements, wireless networks have been under rapid construction. As the network scale becomes larger and larger, the network energy consumption continues to increase, which increases the cost of operators. The main reasons for the increase of energy consumption include:
The number of antennas on the base station side increases significantly, e.g. the typical number of BS antennas in LTE is 4 or 8, however, the typical number of BS antennas in NR is 64;
Wider bandwidth is supported to enable higher data rate, e.g. the maximum of system bandwidth is 100 MHz for C-Band 400 MHz for mm Wave in NR, while the maximum of system bandwidth is 20 MHz in LTE;
With the deployment of mm wave and THz, the inter-site distance is decreased and the network is denser, more sites are needed, which means more power is consumed.

To reduce network energy consumption, equipment vendors and operators have adopted various energy-saving measures to reduce energy consumption both from standardization and realization perspective. Currently, the energy-saving technologies can be classified into device-level, site-level, and network-level energy-saving. Among them, the equipment level focuses on the hardware energy-saving solution research from the component and hardware design. Research on software-based energy-saving solutions at the site level in terms of symbol power saving, channel power saving, carrier power saving, and deep dormancy. Network-level energy-saving terminals implement intelligent energy saving from the perspective of multi-network coordination.

Some key terminologies are listed as following,
PA: power amplifier, a device that efficiently amplifies minute signals to larger signals with small distortion and supplies the amplified signals to a load through a system
DPD: Digital Pre-Distortion (DPD) is one of the most fundamental building blocks in wireless communication systems today. It is used to increase the efficiency of Power Amplifiers. By reducing the distortion created by running Power Amplifiers in their non-linear regions
DAC/ADC: Digital-to-analog converter (DAC) is a system that converts a digital signal into an analog signal. An analog-to-digital converter (ADC) performs the reverse function.
DTX/Cell DTX: Discontinuous Transmission (DTX)/Cell DTX is used for network energy saving, which is a feature in mobile systems where transmitters mute when there is no information to send.
RF channel shutdown: For the multiple input multiple output (MIMO) system, to decrease the network energy saving, when the traffic is low, parts of antennas are muted, or RF channel (at least including PAs and transceiver) is shutdown, which means there is no data transmission on these muted antennas/RF channels.
Carrier shutdown: In commercial cellular network, there are often multi-frequency and multi-mode networks, e.g. low frequency is the basic coverage layer, while high frequency is the capacity layer. During no traffic or extremely low traffic period, the capacity layer could be shut down, which is also called carrier shutdown. When the traffic load exceeds the capacity of basic coverage layer, the capacity cell should be woken up.
Symbol/slot shutdown: When there is no data transmission, some modules at the base station can be shutdown to save power, e.g. PA.
UE battery life is an important aspect of the user's experience, which will influence the adoption of 6G handsets and/or services.

In the current wireless communication system, user equipment (UE, User Equipment) generally has two or three states: a connected state (Connected), an idle state (Idle) and an inactive state (Inactive). When the user equipment is in a connected state, the user equipment may perform data transmission with a network side. When there is no data transmission for a long time, the user equipment enters an idle state. For UE in RRC idle state, power consumption of the UE mainly lies in paging (paging) listening performed by the UE, frequency of cell reselection performed by the UE, frequency of TA update performed by the UE, and so on. For UE in RRC connected state, power consumption is larger than UE in RRC idle state, since UE may perform data transmission with a network side, at the moment, more resources are used, e.g. frequency band, Tx and Rx antennas, transmit power, memory size, hardware consumption, PDCCH detection and so on.

To prolong the UE battery life, various UE power saving techniques are introduced to decrease the power consumption for RRC connected UEs and RRC idle UEs, e.g. DRX, PDCCH based WUS, cross slot scheduling, Scell dormancy, paging early indication, TRS for idle UE, BWP based maximum MIMO layer, measurement relaxation, UE requested RRC release, etc.

Some key terminologies are listed as following,
DRX: Discontinuous reception (DRX) is short for discontinuous reception. In DRX mode, the UE does not continuously monitor the PDCCH. When the UE is in active time of the DRX mode, the UE starts the receiver and listens to the PDCCH to receive downlink data and signaling. In sleep time, the eNodeB stops listening to the PDCCH and stops receiving downlink data and signaling. When the UE is in sleep time, the UE does not listen to the PDCCH or shuts down the receiver to save power. In DRX mode, the DRX cycle consists of the active time and sleep time. The working status of the UE is the active state and sleep state. In non-DRX mode, the UE always turns on the receiver and remains active.
WUS: For the RRC connected UE configured with DRX, a wakeup signal is used to notify the device whether skipping the next DRX monitoring period.
LP-WUS: To further decrease the power consumption of UEs in idle and inactive modes, a low power receiver is enabled at the user terminal besides the main radio, when there is downlink data pending or paging message, a Low power wake up signal (LP-WUS) is sent to the UE to trigger activation of UE's main radio.
PEI: UEs in idle and inactive modes are required to monitor a paging occasion (PO), i.e., decode PDCCH and corresponding PDSCH for paging messages, within each DRX cycle. To improve the UE power saving, a Paging Early Indication (PEI) is sent to UE to indicate whether decoding paging in its Paging occasion.

FIG. 2 illustrates a signaling chart illustrating an example communication process 200 in accordance with some example embodiments of the present disclosure. For the purpose of discussion, the communication process 200 will be described with reference to FIGS. 1A-1D. The communication process 200 may involve a terminal device 210 and a network device 220. The terminal device 210 is an example of UE 110a-110d as illustrated in FIG. 1B. The network device 220 is an example of RAN 120a or 120b or 120c as illustrated in FIG. 1B.

As illustrated in FIG. 2, at block 230, the network device 220 determines first one or more resources for the terminal device 210 to perform transmission. Then, the network device 220 transmits (240), to the terminal device 210, a first indication 201 of the first one or more resources. Here, the first indication 201 may comprise at least three of first time domain information, first frequency domain information, first spatial domain information, or first power domain information of the first one or more resources. On the other side of communication, the terminal device 210 receives (242) the first indication 201.

The network device 220 may further determine second one or more resources for the terminal device 210 to perform reception, and transmits, to the terminal device 210, a second indication of the second one or more resources. Here, the second indication may comprise at least three of second time domain information, second frequency domain information, second spatial domain information, or second power domain information of the second one or more resources. On the other side of communication, the terminal device 210 receives the second indication of second one or more resources for reception. In one example, the first time domain information and the second time domain information may be the same or different. In addition or as an alternative, the first frequency domain information and the second frequency domain information may be the same or different. In addition or as an alternative, the first spatial domain information and the second spatial domain information may be the same or different. More specifically, the first time domain information and the second time domain information may be the same, the first frequency domain information and the second frequency domain information may be the same, and the first spatial domain information and the second spatial domain information may be different. This will be described in more detail with reference to FIGS. 3A, 3B, 3C, 4A, 4B, 5 and 6. In this way, the terminal device can achieve full duplex in time domain and frequency domain, and the resource efficiency can be improved.

The first spatial domain information may indicate at least one beam in a UL beam set, and the second spatial domain information may indicate at least one beam in a DL beam set. This will be described in more detail with reference to FIGS. 3A, 3B, 3C, 4A, 4B, 5 and 6. In this way, unified spectrum utilization can be designed for full duplex, SBFD, TDD and FDD via beam-specific transmission direction indication. In one example, the first spatial domain information indicates a first beam in the UL beam set, and a second beam in the UL beam set, and the first time domain information comprises time domain information for the first beam and time domain information for the second beam which are the same or different. In another example, the second spatial domain information indicates a third beam in the DL beam set, and a fourth beam in the DL beam set, and the second time domain information comprises time domain information for the third beam and time domain information for the fourth beam which are the same or different. In this way, the terminal device can achieve full duplex in time domain and frequency domain, and the resource efficiency can be improved. In still another example, the first spatial domain information indicates a first beam in the UL beam set, and a second beam in the UL beam set, and the first power domain information comprises power domain information for the first beam and power domain information for the second beam which are the same or different. In yet another example, the second spatial domain information indicates a third beam in the DL beam set, and a fourth beam in the DL beam set, and the second power domain information comprises power domain information for the third beam and power domain information for the fourth beam which are the same or different. In this way, unified spectrum utilization can be designed for full duplex, SBFD, TDD and FDD via beam-specific transmission direction indication and power control parameter indication.

In one example, the second spatial domain information may indicate a third beam in the DL beam set, and a fourth beam in the DL beam set, and the second power domain information may comprise power domain information for the third beam and power domain information for the fourth beam which may be the same or different. In this way, unified spectrum utilization can be designed for full duplex, SBFD, TDD and FDD via beam-specific transmission direction indication and power control parameter indication.

In another example, the first indication 201 may be indicative of a first beam which is a UL beam. In this case, the network device 220 may determine that transmission of a first signal via the first beam and reception of a second signal via a second beam are to be performed simultaneously. Here, the second beam may be a DL beam. The network device 220 may then transmit, to the terminal device 210, information indicating that the second signal associated with the second beam is quasi co-located (QCLed) with the first signal associated with the first beam with regard to a quasi co-location (QCL) type, and the quasi co-location (QCL) type may indicate that transmission of the first signal via the first beam and reception of the second signal via the second beam are to be performed simultaneously at the terminal device 210. On the other side of communication, the terminal device 210 may receive, from the network device 220, information indicating that a second signal associated with a second beam is quasi co-located (QCLed) with a first signal associated with the first beam with regard to a quasi co-location (QCL) type. In this case, the first indication 201 may be indicative of a first frame structure for the first beam. The network device 220 may prevent from transmitting, to the terminal device 210, a second frame structure for the second beam. However, based on determining that the second signal associated with the second beam is QCLed with the first signal associated with the first beam with regard to the QCL type, the terminal device 210 may determine a second frame structure for the second beam based on the first frame structure for the first beam, without receiving the second frame structure from the network device 220. This will be described in more detail with reference to FIGS. 4A and 4B. In this way, unified spectrum utilization can be designed for full duplex, SBFD, TDD and FDD via beam-specific transmission direction indication by a newly defined QCL type, and frame structure can be indicated to the terminal device in an implicit way, i.e., without explicit signaling. Therefore, overhead can be reduced.

In still another example, the first indication 201 may be indicative of a first resource and a second resource. The time domain information may comprise first time domain information for the first resource and second time domain information for the second resource, and the first time domain information and the second time domain information may be the same or different. The frequency domain information may comprise first frequency domain information for the first resource and second frequency domain information for the second resource, and the first frequency time domain information and the second frequency domain information may be the same or different. The spatial domain information may comprise first spatial domain information for the first resource and second spatial domain information for the second resource, and the first spatial domain information and the second spatial domain information may be the same or different. In this way, unified spectrum utilization can be designed for full duplex, SBFD, TDD and FDD via beam-specific transmission direction indication.

In yet another example, the first spatial domain information may be indicative of a beam, and the first time domain information may be indicative of a set of symbols for the beam. Here, the set of symbols may include at least one UL symbol. In another example, the second spatial domain information may be indicative of a beam, and the second time domain information may be indicative of a set of symbols for the beam. Here, the set of symbols may include at least one DL symbol. In this way, unified spectrum utilization can be designed for full duplex, SBFD, TDD and FDD via beam-specific transmission direction indication.

In some other examples, the first indication 201 may comprise the first time domain information, the first frequency domain information, and the first spatial domain information. In some other examples, the first indication 201 may further comprise the first power domain information. In this way, unified spectrum utilization can be designed for full duplex, SBFD, TDD and FDD via beam-specific transmission direction indication and power control parameter indication.

For example, the first time domain information may indicate a symbol location of the one or more resources. In addition or as an alternative, the first time domain information may indicate a slot location of the one or more resources. In addition or as an alternative, the first time domain information may indicate a subframe location of the one or more resources. In this way, unified spectrum utilization can be designed for full duplex, SBFD, TDD and FDD via beam-specific transmission direction indication.

For example, the first frequency domain information may indicate carrier information of the one or more resources. In addition or as an alternative, the first frequency domain information may indicate bandwidth part (BWP) information of the one or more resources. In addition or as an alternative, the first frequency domain information may indicate resource block (RB) information of the one or more resources. In this way, unified spectrum utilization can be designed for full duplex, SBFD, TDD and FDD via beam-specific transmission direction indication.

For example, the first spatial domain information may indicate a beam index of the one or more resources. In addition or as an alternative, the first spatial domain information may indicate a beam set of the one or more resources. In addition or as an alternative, the first spatial domain information may indicate MIMO layer information of the one or more resources. In this way, unified spectrum utilization can be designed for full duplex, SBFD, TDD and FDD via beam-specific transmission direction indication.

For example, the first power domain information may indicate at least one power control parameter of the first one or more resources, and the second power domain information may indicate at least one power control parameter of the second one or more resources. For example, the first power domain information and the second power domain information comprise at least one of the following: configured maximum output power in the associated beam, expected receiving power at the receiver node, or a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device may be represented by at least one CSI-RS resource. Alternatively, the first spatial domain information of the first one or more resources for transmission by the terminal device may be represented by at least one sounding reference signal (SRS) resource. In this way, unified spectrum utilization can be designed for full duplex, SBFD, TDD and FDD via beam-specific transmission direction indication.

In this way, according to communication process 200, unified spectrum utilization can be designed for full duplex, SBFD, TDD and FDD via beam-specific transmission direction indication.

Hereinbefore, some examples of the present disclosure are generally described with reference to a high level signaling chart FIG. 2. In the following, some further examples of the present disclosure are described with reference to FIGS. 3A-6.

FIG. 3A illustrates a schematic diagram of an example full duplex 300A by beam isolation in accordance with some embodiments of the present disclosure. For the purpose of discussion, the full duplex 300A will be described with reference to FIG. 1B. The full duplex 300A may involve a network device 310, which is an example of network device 220 as illustrated in FIG. 2, and a terminal device 320, which is an example of terminal device 210 as illustrated in FIG. 2.

As illustrated in FIG. 3A, there are two panels at the network device 310, i.e., panel 311 and panel 31. There are also two panels at the terminal device 320, i.e., panel 321 and panel 322. Therefore, the network device 310 and the terminal device 320 may perform MIMO via the four panels 311, 312, 321 and 322.

In this case, the network device 310 indicates, to the terminal device 320, the resource for reception and/or transmission of the terminal device 320. More specifically, for example, for UE reception resource indication, the resource is 3D resource, i.e., time-frequency-spatial domain resource. The time-domain information of the 3D resource may include at least one of a symbol location, a slot location or a subframe location of the 3D resource. The frequency-domain information of the 3D resource may include one or more of carrier information, bandwidth part (BWP) information or resource block (RB) information of the 3D resource. The spatial-domain information of the 3D resource may include at least one of a beam index, a beam set or MIMO layer information of the 3D resource.

Similarly, for UE transmission resource indication, the resource is 3D resource, i.e., time-frequency-spatial domain resource. The time-domain information of the 3D resource may include at least one of a symbol location, a slot location or a subframe location of the 3D resource. The frequency-domain information of the 3D resource may include one or more of carrier information, bandwidth part (BWP) information or resource block (RB) information of the 3D resource. The spatial-domain information of the 3D resource may include at least one of a beam index, a beam set or MIMO layer information of the 3D resource.

It is to be noted that UE reception resource and UE transmission resource can be separately indicated, e.g. by separate signaling. In other words, the UE reception resource may be indicated via one signaling, while the UE transmission resource may be indicated via another signaling. In doing so, dynamic and more flexible resource indication can be realized. Alternatively, the UE reception resource and UE transmission resource can be indicated by a single signaling. In doing so, signaling overhead to indicate UE reception resource and UE transmission resource can be reduced.

In addition, for UE reception resource indication, the resource can be indicated as Rx, flexible, NA (Non Available), where flexible means it can be Rx or NA. For UE transmission resource indication, the resource can be indicated as Tx, flexible, NA (Non Available), where flexible means it can be Tx or NA.

As illustrated in FIG. 3A, there are two beams for UE transmission (UL) or reception (DL), i.e., a receiving beam (i.e., Rx beam, here, Beam-1), i.e., beam-1, and a transmission beam (i.e., Tx beam, here, Beam-2), i.e., beam-2 for the terminal device 320. For simplicity of discussion, it is assumed that beam-1 can be used for DL reception, and beam-2 can be used for UL transmission.

In the example illustrated in FIG. 3A, it is assumed that the terminal device 320 is a full-duplex UE that can transmit to the network device 310 via an uplink and at the same time receive from the network device 310 via a downlink. Alternatively, the network device 310 may be a full-duplex and the UE communicating with the network device 310 may be a half-duplex UE. In that case, the functions of the terminal device 320 as illustrated in FIG. 3A can be implemented in two terminal devices, one of which uses Beam-1 to receive via the downlink from the network device 310, and the other uses Beam-2 to transmit via the unlink to the network device 310.

FIG. 3B illustrates a schematic diagram of an example frame structure 300B in accordance with some embodiments of the present disclosure. For the purpose of discussion, the frame structure 300B will be described with reference to FIG. 3A.

As described above with reference to FIG. 3A, the network device 310 indicates the reception resource to the terminal device 320. Specifically, the network device 310 indicates a frequency resource (f1, BWP1). Here, f1 is carrier information, which may be, for example, center of a carrier, and BWP1 is the BWP configuration in the carrier, including the BW of the BWP, the starting/center/ending frequency location of the BWP. The network device 310 also indicates the beam resource, for example, beam-1 or beam-2. The network device 310 also indicates the time resource, for example, a symbol location.

More specifically, as illustrated in FIG. 3B on the upper half, for UE reception, the network device 310 indicates (f1, BWP1, beam-1) for the first two symbols of a portion 331 of a slot, and indicates (f1, BWP1, beam-2) for the last four symbols of that portion 331. The portion 331 includes 7 symbols, and may be a half of a slot which the portion belongs. By indicating (f1, BWP1, beam-1) for the first two symbols of the portion 331, the first two symbols of portion 331 is configured by the network device 310 to be used for the terminal device 320 to receive data on frequency resource (f1, BWP1) using beam-1. By indicating (f1, BWP1, beam-2) for the last four symbols of the portion 331, the last four symbols of portion 331 is configured by the network device 310 to be used for the terminal device 320 to receive data on frequency resource (f1, BWP1) using beam-2. With information about the 3 domains indicated by the network device 310, the terminal device 320 knows in the resource of (f1, BWP1) and beam-1, the terminal device 320 could receive in the first two symbols of portion 331. Similarly, in the resource of (f1, BWP1) and beam-2, the terminal device 320 could receive in the last four symbols of portion 331.

In addition or as an alternative, the network device 310 may indicate the transmission resource to the terminal device 320. For example, the network device 310 indicates the frequency resource (f1, BWP1). Here, as mentioned above, f1 is carrier information, which may be, for example, center of a carrier, and BWP1 is the BWP configuration in the carrier, including the BW of the BWP, the starting/center/ending frequency location of the BWP. The network device 310 also indicates the beam resource, for example, beam-1 or beam-2. The network device 310 also indicates the time resource, for example, a symbol location.

More specifically, as illustrated in FIG. 3B on the lower half, for UE transmission, the network device 310 indicates (f1, BWP1, beam-1) for the last four symbols of a portion 332 of a slot, and indicates (f1, BWP1, beam-2) for the first two symbols of the portion 332. The portion 332 includes 7 symbols, and may be a half of a slot which the portion 332 belongs. By indicating (f1, BWP1, beam-1) for the last four symbols of the portion 332, the last four symbols of portion 332 is configured by the network device 310 to be used for the terminal device 320 to transmit data on frequency resource (f1, BWP1) using beam-1. By indicating (f1, BWP1, beam-2) for the first two symbols of the portion 332, the first two symbols of portion 332 is configured by the network device 310 to be used for the terminal device 320 to transmit data on frequency resource (f1, BWP1) using beam-2. With information about the 3 domains indicated by the network device 310, the terminal device 320 knows in the resource of (f1, BWP1) and beam-1, the terminal device 320 could transmit in the last four symbols of portion 332. Similarly, in the resource of (f1, BWP1) and beam-2, the terminal device 320 could transmit in the first two symbols of portion 332. Here, the portion 331 and portion 332 may be one portion labeled with two different signs (here, 331 and 332).

In this way, with the beam-specific resource indication by the network device 310, the terminal device 320 knows it can transmit using beam-2 and receive using beam-1 simultaneously in the first two symbols, and can transmit using beam-1 and receive using beam-2 simultaneously in the last four symbols, enabling full duplex by beam isolation. Therefore, resource utilization efficiency can be improved.

FIG. 3C illustrates a schematic diagram of another example frame structure 300C in accordance with some embodiments of the present disclosure. For the purpose of discussion, the frame structure 300B will be described with reference to FIG. 3A. The frame structure 300C may involve a network device 340, which is an example of network device 220 as illustrated in FIG. 2, and a terminal device 350, which is an example of terminal device 210 as illustrated in FIG. 2.

In this example, DL beam is represented as CSI-RS resource, and UL beam is represented as SRS resource. Before beam-specific resource indication, the network device 340 performs beam management to determine the DL beam set and UL beam set, and then indicates the determined beam set to the terminal device 350.

For one or multiple beams, the network device 340 indicates its Rx or Tx symbol and frequency locations. Multiple beams could have the same Rx or Tx symbol locations. For example, for DL beam 1 and beam 2, the available symbol for UE reception is the same, i.e., the first two symbols.

Specifically, as illustrated in FIG. 3C on the upper half, for UE reception, the network device 340 indicates (f1, BWP1, DL beam-1&2) for the first two symbols of a portion 361 of a slot, and indicates (f1, BWP1, DL beam-3&4) for the last four symbols of the portion 361. The portion 361 includes 7 symbols, and may be a half of a slot which the portion belongs. By indicating (f1, BWP1, DL beam-1&2) for the first two symbols of the portion 361, the first two symbols of portion 361 is configured by the network device 340 to be used for the terminal device 350 to receive data on frequency resource (f1, BWP1) using DL beam-1&2. By indicating (f1, BWP1, DL beam-3&4) for the last four symbols of the portion 361, the last four symbols of portion 362 is configured by the network device 340 to be used for the terminal device 350 to receive data on frequency resource (f1, BWP1) using DL beam-3&4. With information about the 3 domains indicated by the network device 340, the terminal device 350 knows in the resource of (f1, BWP1) and DL beam-1&2, the terminal device 350 could receive in the first two symbols of portion 361. Similarly, in the resource of (f1, BWP1) and DL beam-3&4, the terminal device 350 could receive in the last four symbols of portion 361.

As illustrated in FIG. 3C on the lower half, for UE transmission, the network device 340 indicates (f1, BWP1, UL beam-1) for the last four symbols of a portion 362 of a slot, and indicates (f1, BWP1, UL beam-2) for the first two symbols of the portion 362. The portion 362 includes 7 symbols, and may be a half of a slot which the portion 362 belongs. By indicating (f1, BWP1, UL beam-1) for the last four symbols of the portion 362, the last four symbols of portion 362 is configured by the network device 340 to be used for the terminal device 350 to transmit data on frequency resource (f1, BWP1) using UL beam-1. By indicating (f1, BWP1, UL beam-2) for the first two symbols of the portion 362, the first two symbols of portion 362 is configured by the network device 340 to be used for the terminal device 350 to transmit data on frequency resource (f1, BWP1) using UL beam-2. With information about the 3 domains indicated by the network device 340, the terminal device 350 knows in the resource of (f1, BWP1) and UL beam-1, the terminal device 350 could transmit in the last four symbols of portion 362. Similarly, in the resource of (f1, BWP1) and UL beam-2, the terminal device 350 could transmit in the first two symbols of portion 362. The portion 361 and portion 362 may be one portion labeled with two different signs (here, 361 and 362).

In this way, with the beam-specific resource indication by the network device 340, the terminal device 350 knows it can transmit using UL beam-2 and receive using DL beam-1&2 simultaneously in the first two symbols of portion 361, and can transmit using UL beam-1 and receive using DL beam-3&4 simultaneously in the last four symbols of portion 361, enabling full duplex by beam isolation. Therefore, resource utilization efficiency can be improved.

FIG. 4A illustrates a schematic diagram of an example QCL-type full duplex 400A in accordance with some embodiments of the present disclosure. For the purpose of discussion, the QCL-type full duplex 400A will be described with reference to FIG. 3A. The QCL-type full duplex 400A may involve a network device 410, which is an example of network device 220 as illustrated in FIG. 2, and a terminal device 420, which is an example of terminal device 210 as illustrated in FIG. 2. The QCL-type full duplex 400A in FIG. 4A differs from full duplex 300A in FIG. 3A in that, DL beam-1 and UL beam-2 are QCLed by QCL-Type X, which is a newly defined QCL (Quasi Co Location) type.

For QCL-Type X, a first signal is QCLed by QCL-Type X with a second signal means that, the first signal and the second signal can be simultaneously transmitted and received by a terminal device or network device. For example, it means beam-specific full duplex is enabled when a DL beam (which can be considered as the first signal) and a UL beam (which can be considered as the second signal) are QCLed QCL-Type X.

Specifically, in the example illustrated in FIG. 4A, DL beam-1 and UL beam-2 are QCLed by QCL-Type X. In this case, by indicating the DL beam-1 time locations and the QCL relationship by the network device 410, the terminal device 420 knows, based on the DL beam-1 time locations and the QCL relationship, that UL beam-2 could be used for UL transmission in the same time locations of DL beam-1. For example, based on the DL beam-1 time and frequency locations and the QCL relationship, the terminal device 420 may know that UL beam-2 could be used for UL transmission in the same time and frequency locations of DL beam-1. The beam (including beam-1 and/or beam-2) here can be understood as a direction (beam angle, beam width). In addition, the frequency of UL beam-2 can be the same frequency as DL beam-1, or part of the frequency resource (which may be configured by a base station, for example, by the network device 310) in DL beam-1. In this way, compared with a case where the beam-specific resource indication for UE reception and UE transmission is indicated explicitly by the network device 410 to the terminal device 420, by indicating in an implicit way using the QCL relationship, signaling overhead can be reduced, and communication privacy can be enhanced.

FIG. 4B illustrates a schematic diagram of a further example frame structure 400B in accordance with some embodiments of the present disclosure. FIG. 4B will be described with reference to FIG. 4A. FIG. 4B shows a beam-specific frame structure (FS) indication. Specifically, the network device 410 indicates the Rx frame structure for a DL beam. Then, according to the QCL-TypeX, the terminal device 420 knows the corresponding UL beam Tx frame structure, without indication of corresponding UL beam time locations.

More specifically, the network device 410 indicates the Rx frame structure, i.e., (f1, BWP1, DL beam-1), which indicates the terminal device 420 to receive data on frequency resource (f1, BWP1) using DL beam-1 for the first two symbols of the portion 431 of the slot. In addition, the network device 410 also indicates the QCL relationship (i.e., QCL-TypeX) between DL reception and UL transmission. Therefore, according to the QCL relationship (i.e., QCL-TypeX), the terminal device 420 knows that, it can perform UL transmission using a UL beam (here, UL beam-2) in the first two symbols of the portion 432 on the same frequency resource (f1, BWP1) simultaneously. Here, the portion 431 and portion 432 may be one portion labeled with two different signs (here, 431 and 432). In other words, with knowledge on the QCL relationship (i.e., QCL-TypeX) and the DL beam Rx frame structure indicated by the network device 410, the terminal device 420 knows the corresponding UL beam Tx frame structure, without indication of corresponding UL beam time locations.

In this way, compared with a case where the beam-specific resource indication for UE reception and UE transmission is indicated explicitly by the network device 410 to the terminal device 420 (for example, as the case in the example illustrated in FIGS. 3A, 3B and 3C where there is no QCL-TypeX between DL reception and UL transmission), by indicating in an implicit way using the QCL relationship, signaling overhead can be reduced, and communication privacy can be enhanced.

FIG. 5 illustrates a schematic diagram of a still further example frame structure 500 in accordance with some embodiments of the present disclosure. The frame structure 500 is indicated by a 4D (time-frequency-spatial-power domain) indication. For the purpose of discussion, the frame structure 500 will be described with reference to FIGS. 3A, 3B and 3C.

Specifically, for UE reception resource indication, the resource is 4D resource, i.e., time-frequency-spatial-power domain resource. The time-domain information of the 4D resource may include at least one of a symbol location, a slot location or a subframe location of the 4D resource. The frequency-domain information of the 4D resource may include one or more of carrier information, bandwidth part (BWP) information or resource block (RB) information of the 4D resource. The spatial-domain information of the 4D resource may include at least one of a beam index, a beam set or MIMO layer information of the 4D resource. The power-domain information of the 4D resource may include power control parameters (for DL power control) for the beams indicated in the spatial domain. Here, power control parameters may include at least one of configured maximum output power in the beam, po (expected receiving power at the receiver node) or a pathloss compensation factor.

Similarly, for UE transmission resource indication, the resource is also 4D resource, i.e., time-frequency-spatial-power domain resource. The time-domain information of the 4D resource may include at least one of a symbol location, a slot location or a subframe location of the 4D resource. The frequency-domain information of the 4D resource may include one or more of carrier information, bandwidth part (BWP) information or resource block (RB) information of the 4D resource. The spatial-domain information of the 4D resource may include at least one of a beam index, a beam set or MIMO layer information of the 4D resource. The power-domain information of the 4D resource may include power control parameters (for UL power control) for the beams indicated in the spatial domain. Here, power control parameters may include at least one of configured maximum output power in the beam, po (expected receiving power at the receiver node) or a pathloss compensation factor.

Specifically, as illustrated in FIG. 5 on the upper half, for UE reception, the network device (like the network device 310 as illustrated in FIG. 3A) indicates (f1, beam-1, PC-1) for the first two symbols of a portion 511 of a slot, and indicates (f1, beam-2, PC-2) for the last four symbols of the portion 511. The portion 511 includes 7 symbols, and may be a half of a slot which the portion belongs. “PC” here in “PC-1” and “PC-2” means power control parameters, which may include at least one of configured maximum output power in the beam, po (expected receiving power at the receiver node) or a pathloss compensation factor, as mentioned above. By indicating (f1, beam-1, PC-1) for the first two symbols of the portion 511, the first two symbols of portion 511 is configured by the network device to be used for the terminal device (like the 320 as illustrated in FIG. 3A) to receive data on frequency resource (f1) using beam-1 and power control parameters, i.e., PC-1. By indicating (f1, beam-2, PC-2) for the last four symbols of the portion 511, the last four symbols of portion 511 is configured by the network device to be used for the terminal device to receive data on frequency resource (f1) using beam-2 and PC-2. With information about the 4 domains indicated by the network device, the terminal device knows in the resource of f1, beam-1 and PC-1, the terminal device could receive in the first two symbols of portion 511. Similarly, in the resource of f1, beam-2 and PC-2, the terminal device could receive in the last four symbols of portion 511.

In addition or as an alternative, the network device indicates the transmission resource to the terminal device. As illustrated in FIG. 5 on the lower half, for UE transmission, the network device indicates (f1, beam-1, PC-1) for the last four symbols of a portion 512 of a slot, and indicates (f1, beam-2, PC-2) for the first two symbols of the portion 512. The portion 512 includes 7 symbols, and may be a half of a slot which the portion 512 belongs. By indicating (f1, beam-1, PC-1) for the last four symbols of the portion 512, the last four symbols of portion 512 is configured by the network device to be used for the terminal device to transmit data on frequency resource f1 using beam-1 and PC-1. By indicating (f1, beam-2, PC-2) for the first two symbols of the portion 512, the first two symbols of portion 512 is configured by the network device to be used for the terminal device to transmit data on frequency resource f1 using beam-2 and PC-2. With information about the 4 domains indicated by the network device, the terminal device knows in the resource of f1, beam-1 and PC-1, the terminal device could transmit in the last four symbols of portion 512. Similarly, in the resource of f1, beam-2 and PC-2, the terminal device could transmit in the first two symbols of portion 512. The portion 511 and portion 512 may be one portion labeled with two different signs (here, 511 and 512).

In this way, with the beam-specific resource indication by the network device, the terminal device knows it can transmit using beam-2 and PC-2 and receive using beam-1 and PC-1 simultaneously in the first two symbols of the portion 511, and can transmit using beam-1 and PC-1 and receive using beam-2 and PC-2 simultaneously in the last four symbols, enabling full duplex by beam isolation. Therefore, resource utilization efficiency can be improved.

As mentioned above, for a terminal device, the network device indicates to the terminal device the resource for UE reception and/or UE transmission. For UE reception resource indication, the resource is 3D resource (for example, those examples illustrated in FIGS. 3A, 3B, 3C, 4A and 4B) or 4D resource (for example, the example illustrated in FIG. 5. In each case, time-domain (t1) information of the resource may include at least one of a symbol location, a slot location or a subframe location of the resource. The frequency-domain (f1, BWP1) information of the resource may include at least one of a carrier location or a BWP location. The spatial-domain (beam set 1) information of the resource may include at least one of a beam index, a beam set or MIMO layer information of the resource. The power-domain information of the resource may include specific power control parameters for some symbols/beams/frequency. Here, power control parameters may include at least one of configured maximum output power in the beam, po (expected receiving power at the receiver node) or a pathloss compensation factor. It is to be noted that 3 dimensions can be chosen from the above 4 dimensions.

For example, if the time-frequency-spatial domain is chosen from the above 4 dimensions (i.e., time-frequency-spatial-power domain), it will be similar to the case illustrated in FIGS. 3A, 3B and 3C. In this case, for UE transmission resource indication, the resource is 3D resource. The time-domain (t2) information of the resource may include at least one of a symbol location, a slot location or a subframe location of the resource. The frequency-domain (f2, BWP2) information of the resource may include at least one of a carrier location or a BWP location of the resource. The spatial-domain (beam set 2) information of the resource may include at least one of a beam index, a beam set or MIMO layer information of the resource. The power-domain information of the resource may include specific power control parameters for some symbols/beams/frequency. Here, power control parameters may include at least one of configured maximum output power in the beam, po (expected receiving power at the receiver node) or a pathloss compensation factor. The 3D resource consists of resources in 3D selected from the above 4D (i.e., time-frequency-spatial-power domain). If the selected 3D is time-frequency-spatial domain, it will be similar to the case illustrated in FIGS. 3A, 3B and 3C.

The 3D resource supports totally decoupled spectrum utilization, and selecting one DL frequency in the available DL carriers and selecting one UL frequency in the available UL carriers are also supported. In this way, super flexible spectrum utilization is enabled.

In some other embodiments, for UE reception indication, the network device indicates (f1, BWP1, t1, beam set 1), and for UE transmission, the network device indicate BS indicates (f2, BWP2, t2, beam set 2). Here, t1 and t2, f1 and f2, BWP1 and BWP2, beam set 1 and beam set 2 can be same or different. For multiple resources indication for reception, the network device indicates multiple combinations of (f_i, BWP_i, t_i, beam set_i). Here, i=1 to N, N>1, and for combination k and combination j, t_k and t_j, f_k and f_j, BWP_k and BWP_j, beam set_k and beam set_j can be same or different. For multiple resources indication for transmission, the network device indicates multiple combinations of (f_i, BWP_i, t_i, beam set_i), where i=1 to N, N>1, and for combination k and combination j, t_k and t_j, f_k and f_j, BWP_k and BWP_j, beam set_k and beam set_j can be same or different. In this way, unified spectrum utilization can be designed for full duplex, SBFD, TDD and FDD via beam-specific transmission direction indication.

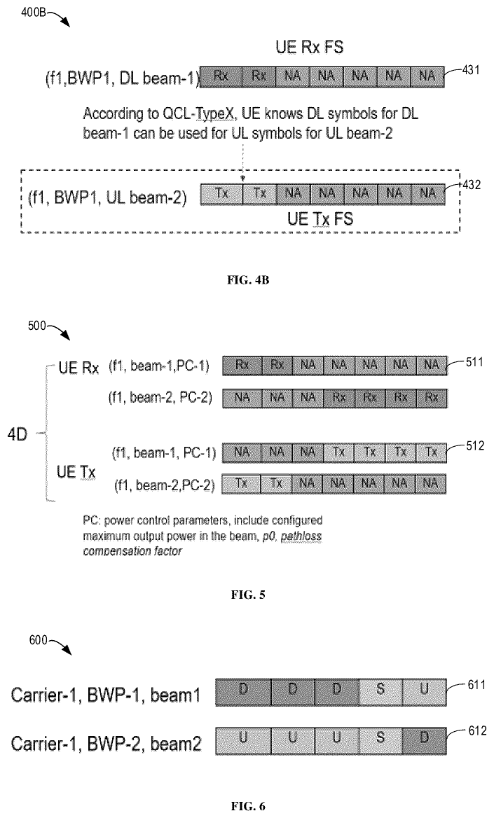

For the time-domain indication in 4D resource, a joint indication for reception and transmission can be used. This will be described in more detail with reference to FIG. 6.

FIG. 6 illustrates a schematic diagram of a still further example frame structure 600 in accordance with some embodiments of the present disclosure. For the purpose of discussion, the frame structure 600 will be described with reference to FIGS. 3A and 5. The difference from the above embodiment as illustrated in FIGS. 3A-5 is: the above embodiment indicates the UE reception resource and UE transmission resource in a separate way, while the UE reception resource and UE transmission resource are indicated together in the example illustrated in FIG. 6.

As illustrated in FIG. 6, the network device indicates the DL and UL symbols for beam 1 in BWP-1, and indicates the DL and UL symbols for beam 2 in BWP-2. BWP-1 is used here for purpose of simplicity. At DL time, BWP-1 represents a DL BWP, while at UL time, BWP-1 represents an UL BWP.

Specifically, the network device (like the network device 310 as illustrated in FIG. 3A) indicates (Carrier-1, BWP-1, beam1) for a portion 611 of a slot, and indicates (Carrier-1, BWP-2, beam2) for a portion 612 of a slot. The portion 611 and portion 612 each includes 5 symbols, and the portion 611 and portion 612 may be one portion labeled with two different signs (here, 611 and 612). More specifically, taken the first three symbols of the portion 611 for example, the network device indicates (Carrier-1, BWP-1, beam1) for the first three symbols in portion 611 to be used by the terminal device for DL reception, and indicates (Carrier-1, BWP-2, beam2) for the first three symbols in portion 612 to be used by the terminal device for UL transmission.

In this way, with the beam-specific resource indication by the network device, the terminal device knows it can transmit using beam2 on BWP-2 and receive using beam1 on BWP-1 simultaneously in the first three symbols, enabling full duplex by beam isolation. Therefore, resource utilization efficiency can be improved.

FIG. 7 illustrates a flowchart of an example method 700 implemented at a terminal device in accordance with some other embodiments of the present disclosure. For the purpose of discussion, the method 700 will be described from the perspective of the terminal device 210 with reference to FIG. 2.

At block 710, the terminal device 210 receives a first indication of first one or more resources for transmission (for example, the first indication 201 as illustrated in FIG. 2). Here, the first indication may comprise at least three of first time domain information, first frequency domain information, first spatial domain information, or first power domain information of the first one or more resources.

In some example embodiments, the terminal device 210 may further receive a second indication of second one or more resources for reception. Here, the second indication may comprise at least three of second time domain information, second frequency domain information, second spatial domain information, or second power domain information of the second one or more resources. In this way, unified spectrum utilization can be designed for full duplex, SBFD, TDD and FDD via beam-specific transmission direction indication.

In some example embodiments, the first time domain information and the second time domain information may be the same or different. In addition or as an alternative, the first frequency domain information and the second frequency domain information may be the same or different. In addition or as an alternative, the first spatial domain information and the second spatial domain information may be the same or different. In this way, unified spectrum utilization can be designed for full duplex, SBFD, TDD and FDD via beam-specific transmission direction indication.

In some example embodiments, the first time domain information and the second time domain information may be the same, the first frequency domain information and the second frequency domain information may be the same, and the first spatial domain information and the second spatial domain information may be different. In this way, the terminal device 210 can achieve full duplex in time domain and frequency domain, and the resource efficiency can be improved.

In some example embodiments, the first spatial domain information may indicate at least one beam in a UL beam set, and the second spatial domain information may indicate at least one beam in a DL beam set. In this way, unified spectrum utilization can be designed for full duplex, SBFD, TDD and FDD via beam-specific transmission direction indication.

In some example embodiments, the first spatial domain information may indicate a first beam in the UL beam set, and a second beam in the UL beam set, and the first time domain information may comprise time domain information for the first beam and time domain information for the second beam which may be the same or different. In this way, the terminal device 210 can achieve full duplex in time domain and frequency domain, and the resource efficiency can be improved.

In some example embodiments, the second spatial domain information may indicate a third beam in the DL beam set, and a fourth beam in the DL beam set, and the second time domain information may comprise time domain information for the third beam and time domain information for the fourth beam which may be the same or different. In this way, the terminal device 210 can achieve full duplex in time domain and frequency domain, and the resource efficiency can be improved.

In some example embodiments, the first spatial domain information may indicate a first beam in the UL beam set, and a second beam in the UL beam set, and the first power domain information may comprise power domain information for the first beam and power domain information for the second beam which may be the same or different. In this way, unified spectrum utilization can be designed for full duplex, SBFD, TDD and FDD via beam-specific transmission direction indication and power control parameter indication.

In some example embodiments, the second spatial domain information may indicate a third beam in the DL beam set, and a fourth beam in the DL beam set, and the second power domain information may comprise power domain information for the third beam and power domain information for the fourth beam which may be the same or different. In this way, unified spectrum utilization can be designed for full duplex, SBFD, TDD and FDD via beam-specific transmission direction indication and power control parameter indication.

In some example embodiments, the first indication may be indicative of a first beam which is a UL beam, and terminal device 210 may further receive, from a network device (for example, the network device 220 as illustrated in FIG. 2), information indicating that a second signal associated with a second beam may be quasi co-located (QCLed) with a first signal associated with the first beam with regard to a quasi co-location (QCL) type. Here, the second beam may be a DL beam, and the quasi co-location (QCL) type may indicate that transmission of the first signal via the first beam and reception of the second signal via the second beam may be performed simultaneously. In this way, unified spectrum utilization can be designed for full duplex, SBFD, TDD and FDD via beam-specific transmission direction indication by a newly defined QCL type.

In some example embodiments, the first indication may be indicative of a first frame structure for the first beam, and the terminal device 210 may further determine, based on determining that the second signal associated with the second beam is QCLed with the first signal associated with the first beam with regard to the QCL type, a second frame structure for the second beam based on the first frame structure for the first beam, without receiving the second frame structure from the network device. In this way, unified spectrum utilization can be designed for full duplex, SBFD, TDD and FDD via beam-specific transmission direction indication by a newly defined QCL type.

In some example embodiments, the first indication may be indicative of a first resource and a second resource. The time domain information may comprise first time domain information for the first resource and second time domain information for the second resource, and the first time domain information and the second time domain information may be the same or different. The frequency domain information may comprise first frequency domain information for the first resource and second frequency domain information for the second resource, and the first frequency time domain information and the second frequency domain information may be the same or different. The spatial domain information may comprise first spatial domain information for the first resource and second spatial domain information for the second resource, and the first spatial domain information and the second spatial domain information are the same or different. In this way, unified spectrum utilization can be designed for full duplex, SBFD, TDD and FDD via beam-specific transmission direction indication.

In some example embodiments, the first spatial domain information may be indicative of a beam, and the first time domain information may be indicative of a set of symbols for the beam. Here, the set of symbols may include at least one UL symbol. In this way, unified spectrum utilization can be designed for full duplex, SBFD, TDD and FDD via beam-specific transmission direction indication.

In some example embodiments, the second spatial domain information may be indicative of a beam, and the second time domain information may be indicative of a set of symbols for the beam. Here, the set of symbols may include at least one DL symbol. In this way, unified spectrum utilization can be designed for full duplex, SBFD, TDD and FDD via beam-specific transmission direction indication.

In some example embodiments, the first indication may comprise the first time domain information, the first frequency domain information, and the first spatial domain information. In this way, unified spectrum utilization can be designed for full duplex, SBFD, TDD and FDD via beam-specific transmission direction indication.

In some example embodiments, the first indication may further comprise the first power domain information. In this way, unified spectrum utilization can be designed for full duplex, SBFD, TDD and FDD via beam-specific transmission direction indication and power control parameter indication.

In some example embodiments, the first time domain information may indicate a symbol location of the one or more resources. In addition or as an alternative, the first time domain information may indicate a slot location of the one or more resources. In addition or as an alternative, the first time domain information may indicate a subframe location of the one or more resources. In this way, unified spectrum utilization can be designed for full duplex, SBFD, TDD and FDD via beam-specific transmission direction indication.

In some example embodiments, the first frequency domain information may indicate carrier information of the one or more resources. In addition or as an alternative, the first frequency domain information may indicate bandwidth part (BWP) information of the one or more resources. In addition or as an alternative, the first frequency domain information may indicate resource block (RB) information of the one or more resources. In this way, unified spectrum utilization can be designed for full duplex, SBFD, TDD and FDD via beam-specific transmission direction indication.

In some example embodiments, the first spatial domain information may indicate a beam index of the one or more resources. In addition or as an alternative, the first spatial domain information may indicate a beam set of the one or more resources. In addition or as an alternative, the first spatial domain information may indicate multiple-input multiple-output (MIMO) layer information of the one or more resources. In this way, unified spectrum utilization can be designed for full duplex, SBFD, TDD and FDD via beam-specific transmission direction indication.

In some example embodiments, the first power domain information may indicate at least one power control parameter of the first one or more resources, and the second power domain information may indicate at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information may comprise configured maximum output power in the associated beam. In addition or as an alternative, the first power domain information and the second power domain information may comprise expected receiving power at the receiver node. In addition or as an alternative, the first power domain information and the second power domain information may comprise a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device 210 may be represented by at least one channel state information (CSI)-reference signal (RS) resource. Alternatively, the first spatial domain information of the first one or more resources for transmission by the terminal device 210 may be represented by at least one sounding reference signal (SRS) resource. In this way, unified spectrum utilization can be designed for full duplex, SBFD, TDD and FDD via beam-specific transmission direction indication.

In this way, according to method 700, unified spectrum utilization can be designed for full duplex, SBFD, TDD and FDD via beam-specific transmission direction indication.

FIG. 8 illustrates another flowchart of an example method 800 implemented at a network device in accordance with some other embodiments of the present disclosure. For the purpose of discussion, the method 800 will be described from the perspective of the network device 220 with reference to FIG. 2.

At block 810, the network device 220 determines first one or more resources for a terminal device (for example, terminal device 210 as illustrated in FIG. 2) to perform transmission. At block 820, the network device 220 transmits, to the terminal device, a first indication of the first one or more resources (for example, the first indication 201 as illustrated in FIG. 2). Here, the first indication may comprise at least three of first time domain information, first frequency domain information, first spatial domain information, or first power domain information of the first one or more resources.

In some example embodiments, the network device 220 may further determine second one or more resources for the terminal device to perform reception, and transmit, to the terminal device, a second indication of the second one or more resources. Here, the second indication may comprise at least three of second time domain information, second frequency domain information, second spatial domain information, or second power domain information of the second one or more resources. In this way, unified spectrum utilization can be designed for full duplex, SBFD, TDD and FDD via beam-specific transmission direction indication

In some example embodiments, the first time domain information and the second time domain information may be the same or different. In addition or as an alternative, the first frequency domain information and the second frequency domain information may be the same or different. In addition or as an alternative, the first spatial domain information and the second spatial domain information may be the same or different. In this way, unified spectrum utilization can be designed for full duplex, SBFD, TDD and FDD via beam-specific transmission direction indication

In some example embodiments, the first time domain information and the second time domain information may be the same. In addition or as an alternative, the first frequency domain information and the second frequency domain information may be the same. In addition or as an alternative, the first spatial domain information and the second spatial domain information may be different. In this way, the terminal device can achieve full duplex in time domain and frequency domain, and the resource efficiency can be improved.

In some example embodiments, the first spatial domain information may indicate at least one beam in a UL beam set, and the second spatial domain information may indicate at least one beam in a DL beam set. In this way, unified spectrum utilization can be designed for full duplex, SBFD, TDD and FDD via beam-specific transmission direction indication.

In some example embodiments, the first spatial domain information may indicate a first beam in the UL beam set, and a second beam in the UL beam set, and the first time domain information may comprise time domain information for the first beam and time domain information for the second beam which may be the same or different. In this way, the terminal device can achieve full duplex in time domain and frequency domain, and the resource efficiency can be improved.

In some example embodiments, the second spatial domain information may indicate a third beam in the DL beam set, and a fourth beam in the DL beam set, and the second time domain information may comprise time domain information for the third beam and time domain information for the fourth beam which may be the same or different. In this way, the terminal device can achieve full duplex in time domain and frequency domain, and the resource efficiency can be improved.

In some example embodiments, the first spatial domain information may indicate a first beam in the UL beam set, and a second beam in the UL beam set, and the first power domain information may comprise power domain information for the first beam and power domain information for the second beam which may be the same or different. In this way, unified spectrum utilization can be designed for full duplex, SBFD, TDD and FDD via beam-specific transmission direction indication and power control parameter indication.

In some example embodiments, the second spatial domain information may indicate a third beam in the DL beam set, and a fourth beam in the DL beam set, and the second power domain information may comprise power domain information for the third beam and power domain information for the fourth beam which may be the same or different. In this way, unified spectrum utilization can be designed for full duplex, SBFD, TDD and FDD via beam-specific transmission direction indication and power control parameter indication.

In some example embodiments, the first indication may be indicative of a first beam which may be a UL beam, and the network device 220 may further determine that transmission of a first signal via the first beam and reception of a second signal via a second beam are to be performed simultaneously. Here, the second beam may be a DL beam. The network device 220 may transmit, to the terminal device, information indicating that the second signal associated with the second beam may be quasi co-located (QCLed) with the first signal associated with the first beam with regard to a quasi co-location (QCL) type, and the quasi co-location (QCL) type may indicate that transmission of the first signal via the first beam and reception of the second signal via the second beam may be performed simultaneously at the terminal device. In this way, unified spectrum utilization can be designed for full duplex, SBFD, TDD and FDD via beam-specific transmission direction indication by a newly defined QCL type.

In some example embodiments, the first indication may be indicative of a first frame structure for the first beam, and the network device 220 may further prevent from transmitting, to the terminal device, a second frame structure for the second beam. In this way, unified spectrum utilization can be designed for full duplex, SBFD, TDD and FDD via beam-specific transmission direction indication by a newly defined QCL type, and frame structure can be indicated to the terminal device in an implicit way, i.e., without explicit signaling. Therefore, overhead can be reduced.

In some example embodiments, the first indication may be indicative of a first resource and a second resource. The time domain information may comprise first time domain information for the first resource and second time domain information for the second resource, and the first time domain information and the second time domain information may be the same or different. The frequency domain information may comprise first frequency domain information for the first resource and second frequency domain information for the second resource, and the first frequency time domain information and the second frequency domain information may be the same or different. The spatial domain information may comprise first spatial domain information for the first resource and second spatial domain information for the second resource, and the first spatial domain information and the second spatial domain information may be the same or different. In this way, unified spectrum utilization can be designed for full duplex, SBFD, TDD and FDD via beam-specific transmission direction indication.

In some example embodiments, the first spatial domain information may be indicative of a beam, and the first time domain information may be indicative of a set of symbols for the beam. Here, the set of symbols may include at least one UL symbol. In this way, unified spectrum utilization can be designed for full duplex, SBFD, TDD and FDD via beam-specific transmission direction indication.

In some example embodiments, the second spatial domain information may be indicative of a beam, and the second time domain information may be indicative of a set of symbols for the beam. Here, the set of symbols may include at least one DL symbol. In this way, unified spectrum utilization can be designed for full duplex, SBFD, TDD and FDD via beam-specific transmission direction indication.

In some example embodiments, the first indication may comprise the first time domain information, the first frequency domain information, and the first spatial domain information. In this way, unified spectrum utilization can be designed for full duplex, SBFD, TDD and FDD via beam-specific transmission direction indication.

In some example embodiments, the first indication may further comprise the first power domain information. In this way, unified spectrum utilization can be designed for full duplex, SBFD, TDD and FDD via beam-specific transmission direction indication and power control parameter indication.

In some example embodiments, the first time domain information may indicate a symbol location of the one or more resources. In addition or as an alternative, the first time domain information may indicate a slot location of the one or more resources. In addition or as an alternative, the first time domain information may indicate a subframe location of the one or more resources. In this way, unified spectrum utilization can be designed for full duplex, SBFD, TDD and FDD via beam-specific transmission direction indication.

In some example embodiments, the first frequency domain information may indicate carrier information of the one or more resources. In addition or as an alternative, the first frequency domain information may indicate bandwidth part (BWP) information of the one or more resources. In addition or as an alternative, the first frequency domain information may indicate resource block (RB) information of the one or more resources. In this way, unified spectrum utilization can be designed for full duplex, SBFD, TDD and FDD via beam-specific transmission direction indication.

In some example embodiments, the first spatial domain information may indicate a beam index of the one or more resources. In addition or as an alternative, the first spatial domain information may indicate a beam set of the one or more resources. In addition or as an alternative, the first spatial domain information may indicate multiple-input multiple-output (MIMO) layer information. In this way, unified spectrum utilization can be designed for full duplex, SBFD, TDD and FDD via beam-specific transmission direction indication.

In some example embodiments, the first power domain information may indicate at least one power control parameter of the first one or more resources, and the second power domain information may indicate at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information may comprise configured maximum output power in the associated beam. In addition or as an alternative, the first power domain information and the second power domain information may comprise expected receiving power at the receiver node. In addition or as an alternative, the first power domain information and the second power domain information may comprise a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device may be represented by at least one channel state information (CSI)-reference signal (RS) resource. Alternatively, the first spatial domain information of the first one or more resources for transmission by the terminal device may be represented by at least one sounding reference signal (SRS) resource. In this way, unified spectrum utilization can be designed for full duplex, SBFD, TDD and FDD via beam-specific transmission direction indication.

In this way, according to method 800, unified spectrum utilization can be designed for full duplex, SBFD, TDD and FDD via beam-specific transmission direction indication.

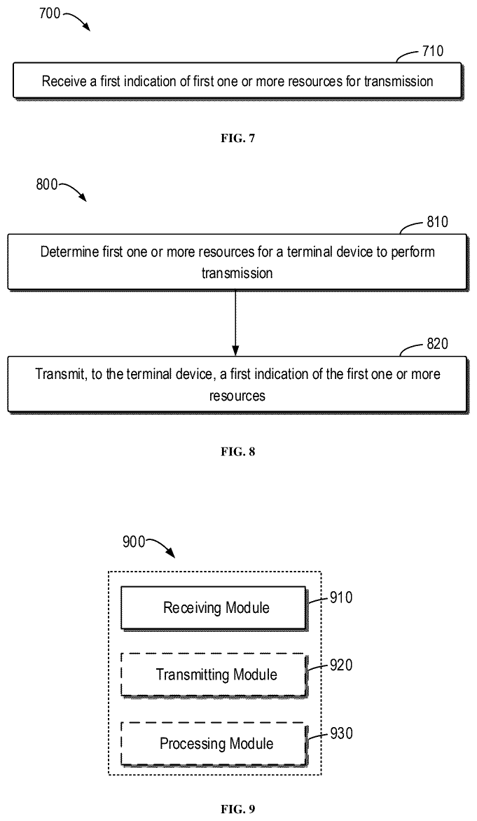

FIG. 9 illustrates a simplified block diagram of an apparatus 900 according to some example embodiments of the present disclosure. The apparatus 900 may be implemented as a device or a chip in the device, and the scope of the present application is not limited in this respect. The apparatus 900 may include multiple modules for performing corresponding processes in the method 700 as discussed in FIG. 7. The apparatus 900 may be implemented as the terminal device 210 as shown in FIG. 2 or a part of the terminal device 210. FIG. 9 will be described below with reference to FIGS. 1B, 2 and 7.

As illustrated in FIG. 9, the apparatus 900 comprises a receiving module 910. The apparatus 900 may further comprise a transmitting module 920 and obtaining processing module 930. The receiving module 910 is used to receive data (for example, indication of one or more resources for transmission). The transmitting module 920 may be used to transmit data, and the processing module 930 may be used to process data. For example, the receiving module 910 is configured to receive, by a terminal device (for example, the terminal device 210 as illustrated in FIG. 2), a first indication of first one or more resources for transmission (for example, the first indication 201 as illustrated in FIG. 2). Here, the first indication may comprise at least three of first time domain information, first frequency domain information, first spatial domain information, or first power domain information of the first one or more resources.

In some example embodiments, the apparatus 900 may further comprise a receiving module configured to receive, by the terminal device, a second indication of second one or more resources for reception. Here, the second indication may comprise at least three of second time domain information, second frequency domain information, second spatial domain information, or second power domain information of the second one or more resources. In this way, unified spectrum utilization can be designed for full duplex, SBFD, TDD and FDD via beam-specific transmission direction indication

In some example embodiments, the first time domain information and the second time domain information may be the same or different. In addition or as an alternative, the first frequency domain information and the second frequency domain information may be the same or different. In addition or as an alternative, the first spatial domain information and the second spatial domain information may be the same or different. In this way, unified spectrum utilization can be designed for full duplex, SBFD, TDD and FDD via beam-specific transmission direction indication

In some example embodiments, the first time domain information and the second time domain information may be the same, the first frequency domain information and the second frequency domain information may be the same, and the first spatial domain information and the second spatial domain information may be different. In this way, the terminal device can achieve full duplex in time domain and frequency domain, and the resource efficiency can be improved.

In some example embodiments, the first spatial domain information may indicate at least one beam in a UL beam set, and the second spatial domain information may indicate at least one beam in a DL beam set. In this way, unified spectrum utilization can be designed for full duplex, SBFD, TDD and FDD via beam-specific transmission direction indication.

In some example embodiments, the first spatial domain information may indicate a first beam in the UL beam set, and a second beam in the UL beam set, and the first time domain information may comprise time domain information for the first beam and time domain information for the second beam which may be the same or different. In this way, the terminal device can achieve full duplex in time domain and frequency domain, and the resource efficiency can be improved.

In some example embodiments, the second spatial domain information may indicate a third beam in the DL beam set, and a fourth beam in the DL beam set, and the second time domain information may comprise time domain information for the third beam and time domain information for the fourth beam which may be the same or different. In this way, the terminal device can achieve full duplex in time domain and frequency domain, and the resource efficiency can be improved.

In some example embodiments, the first spatial domain information may indicate a first beam in the UL beam set, and a second beam in the UL beam set, and the first power domain information may comprise power domain information for the first beam and power domain information for the second beam which may be the same or different. In this way, unified spectrum utilization can be designed for full duplex, SBFD, TDD and FDD via beam-specific transmission direction indication and power control parameter indication.

In some example embodiments, the second spatial domain information may indicate a third beam in the DL beam set, and a fourth beam in the DL beam set, and the second power domain information may comprise power domain information for the third beam and power domain information for the fourth beam which may be the same or different. In this way, unified spectrum utilization can be designed for full duplex, SBFD, TDD and FDD via beam-specific transmission direction indication and power control parameter indication.

In some example embodiments, the first indication may be indicative of a first beam which may be a UL beam, and the apparatus 900 may further comprise a receiving module configured to receive, from a network device (for example, the network device 220 as illustrated in FIG. 2), information indicating that a second signal associated with a second beam is quasi co-located (QCLed) with a first signal associated with the first beam with regard to a quasi co-location (QCL) type. Here, the second beam may be a DL beam, and the quasi co-location (QCL) type may indicate that transmission of the first signal via the first beam and reception of the second signal via the second beam may be performed simultaneously. In this way, unified spectrum utilization can be designed for full duplex, SBFD, TDD and FDD via beam-specific transmission direction indication by a newly defined QCL type.

In some example embodiments, the first indication may be indicative of a first frame structure for the first beam, and the apparatus 900 may further comprise a determining module configure to determine, based on determining that the second signal associated with the second beam is QCLed with the first signal associated with the first beam with regard to the QCL type, a second frame structure for the second beam based on the first frame structure for the first beam, without receiving the second frame structure from the network device. In this way, unified spectrum utilization can be designed for full duplex, SBFD, TDD and FDD via beam-specific transmission direction indication by a newly defined QCL type.

In some example embodiments, the first indication may be indicative of a first resource and a second resource. The time domain information may comprise first time domain information for the first resource and second time domain information for the second resource, and the first time domain information and the second time domain information may be the same or different. The frequency domain information may comprise first frequency domain information for the first resource and second frequency domain information for the second resource, and the first frequency time domain information and the second frequency domain information may be the same or different. The spatial domain information may comprise first spatial domain information for the first resource and second spatial domain information for the second resource, and the first spatial domain information and the second spatial domain information may be the same or different. In this way, unified spectrum utilization can be designed for full duplex, SBFD, TDD and FDD via beam-specific transmission direction indication.

In some example embodiments, the first spatial domain information may be indicative of a beam, and the first time domain information may be indicative of a set of symbols for the beam, wherein the set of symbols includes at least one UL symbol. In this way, unified spectrum utilization can be designed for full duplex, SBFD, TDD and FDD via beam-specific transmission direction indication.

In some example embodiments, the second spatial domain information may be indicative of a beam, and the second time domain information may be indicative of a set of symbols for the beam. Here, the set of symbols includes at least one DL symbol. In this way, unified spectrum utilization can be designed for full duplex, SBFD, TDD and FDD via beam-specific transmission direction indication.

In some example embodiments, the first indication may comprise the first time domain information, the first frequency domain information, and the first spatial domain information. In this way, unified spectrum utilization can be designed for full duplex, SBFD, TDD and FDD via beam-specific transmission direction indication.

In some example embodiments, the first indication may further comprise the first power domain information. In this way, unified spectrum utilization can be designed for full duplex, SBFD, TDD and FDD via beam-specific transmission direction indication and power control parameter indication.

In some example embodiments, the first time domain information may indicate a symbol location of the one or more resources. In addition or as an alternative, the first time domain information may indicate a slot location of the one or more resources. In addition or as an alternative, the first time domain information may indicate a subframe location of the one or more resources. In this way, unified spectrum utilization can be designed for full duplex, SBFD, TDD and FDD via beam-specific transmission direction indication.

In some example embodiments, the first frequency domain information may indicate carrier information of the one or more resources. In addition or as an alternative, the first frequency domain information may indicate bandwidth part (BWP) information of the one or more resources. In addition or as an alternative, the first frequency domain information may indicate resource block (RB) information of the one or more resources. In this way, unified spectrum utilization can be designed for full duplex, SBFD, TDD and FDD via beam-specific transmission direction indication.

In some example embodiments, the first spatial domain information may indicate a beam index of the one or more resources. In addition or as an alternative, the first spatial domain information may indicate a beam set of the one or more resources. In addition or as an alternative, the first spatial domain information may indicate multiple-input multiple-output (MIMO) layer information of the one or more resources. In this way, unified spectrum utilization can be designed for full duplex, SBFD, TDD and FDD via beam-specific transmission direction indication.

In some example embodiments, the first power domain information may indicate at least one power control parameter of the first one or more resources, and the second power domain information may indicate at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information may comprise configured maximum output power in the associated beam. In addition or as an alternative, the first power domain information and the second power domain information may comprise expected receiving power at the receiver node. In addition or as an alternative, the first power domain information and the second power domain information may comprise a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device may be represented by at least one channel state information (CSI)-reference signal (RS) resource. Alternatively, the first spatial domain information of the first one or more resources for transmission by the terminal device may be represented by at least one sounding reference signal (SRS) resource. In this way, unified spectrum utilization can be designed for full duplex, SBFD, TDD and FDD via beam-specific transmission direction indication.

In this way, according to apparatus 900, unified spectrum utilization can be designed for full duplex, SBFD, TDD and FDD via beam-specific transmission direction indication.

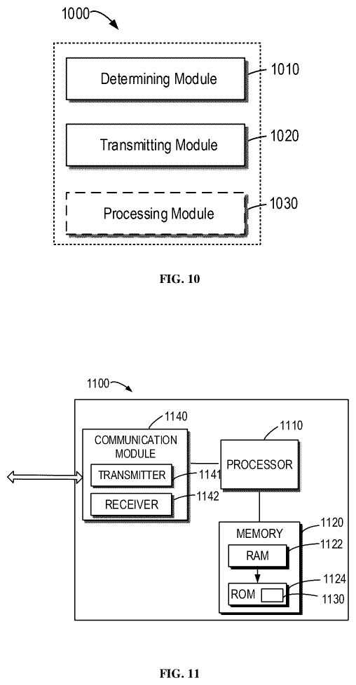

FIG. 10 illustrates a simplified block diagram of an apparatus 1000 according to some example embodiments of the present disclosure. The apparatus 1000 may be implemented as a device or a chip in the device, and the scope of the present application is not limited in this respect. The apparatus 1000 may include multiple modules for performing corresponding processes in the method 800 as discussed in FIG. 8. The apparatus 1000 may be implemented as the network device 220 as shown in FIG. 1B or 2 or a part of the network device 220. FIG. 10 will be described below with reference to FIGS. 1B, 2 and 8.

As illustrated in FIG. 10, the apparatus 1000 comprises a determining module 1010 and a transmitting module 1020. The apparatus 1000 may further comprise a processing module 1030. The determining module 1010 is used to determine data (for example, to determine one or more resources for a terminal device to perform transmission), and the transmitting module 1020 is used to transmit data (for example, to transmit indication of one or more resources). The processing module 1030 may be used to process data. For example, the determining module 1010 is configured to determine, at a network device 220, first one or more resources for a terminal device (for example, the terminal device 210 as illustrated in FIG. 2) to perform transmission. The transmitting module 1020 is configured to transmit, to the terminal device, a first indication of the first one or more resources (for example, the first indication 201 as illustrated in FIG. 2). Here, the first indication may comprise at least three of first time domain information, first frequency domain information, first spatial domain information, or first power domain information of the first one or more resources.

In some example embodiments, the apparatus 1000 may further comprise a determining module configured to determine, at a network device (for example, the network device 220 as illustrated in FIG. 2), second one or more resources for the terminal device to perform reception, and a transmitting module configured to transmit, to a terminal device (for example, the terminal device 210 as illustrated in FIG. 2), a second indication of the second one or more resources. Here, the second indication may comprise at least three of second time domain information, second frequency domain information, second spatial domain information, or second power domain information of the second one or more resources. In this way, unified spectrum utilization can be designed for full duplex, SBFD, TDD and FDD via beam-specific transmission direction indication

In some example embodiments, the first time domain information and the second time domain information may be the same or different. In addition or as an alternative, the first frequency domain information and the second frequency domain information may be the same or different. In addition or as an alternative, the first spatial domain information and the second spatial domain information may be the same or different. In this way, unified spectrum utilization can be designed for full duplex, SBFD, TDD and FDD via beam-specific transmission direction indication

In some example embodiments, the first time domain information and the second time domain information may be the same, the first frequency domain information and the second frequency domain information may be the same, and the first spatial domain information and the second spatial domain information may be different. In this way, the terminal device can achieve full duplex in time domain and frequency domain, and the resource efficiency can be improved.

In some example embodiments, the first spatial domain information may indicate at least one beam in a UL beam set, and the second spatial domain information may indicate at least one beam in a DL beam set. In this way, unified spectrum utilization can be designed for full duplex, SBFD, TDD and FDD via beam-specific transmission direction indication.

In some example embodiments, the first spatial domain information may indicate a first beam in the UL beam set, and a second beam in the UL beam set, and the first time domain information may comprise time domain information for the first beam and time domain information for the second beam which may be the same or different. In this way, the terminal device can achieve full duplex in time domain and frequency domain, and the resource efficiency can be improved.

In some example embodiments, the second spatial domain information may indicate a third beam in the DL beam set, and a fourth beam in the DL beam set, and the second time domain information may comprise time domain information for the third beam and time domain information for the fourth beam which may be the same or different. In this way, the terminal device can achieve full duplex in time domain and frequency domain, and the resource efficiency can be improved.

In some example embodiments, the first spatial domain information may indicate a first beam in the UL beam set, and a second beam in the UL beam set, and the first power domain information may comprise power domain information for the first beam and power domain information for the second beam which may be the same or different. In this way, unified spectrum utilization can be designed for full duplex, SBFD, TDD and FDD via beam-specific transmission direction indication and power control parameter indication.

In some example embodiments, the second spatial domain information may indicate a third beam in the DL beam set, and a fourth beam in the DL beam set, and the second power domain information may comprise power domain information for the third beam and power domain information for the fourth beam which may be the same or different. In this way, unified spectrum utilization can be designed for full duplex, SBFD, TDD and FDD via beam-specific transmission direction indication and power control parameter indication.

In some example embodiments, the first indication may be indicative of a first beam which is a UL beam, and the apparatus 1000 may further comprise a determining module configured to determine that transmission of a first signal via the first beam and reception of a second signal via a second beam are to be performed simultaneously. Here, the second beam may be a DL beam. The apparatus 1000 may further comprise a transmitting module configured to transmit, to the terminal device, information indicating that the second signal associated with the second beam may be quasi co-located (QCLed) with the first signal associated with the first beam with regard to a quasi co-location (QCL) type, and the quasi co-location (QCL) type may indicate that transmission of the first signal via the first beam and reception of the second signal via the second beam may be performed simultaneously at the terminal device. In this way, unified spectrum utilization can be designed for full duplex, SBFD, TDD and FDD via beam-specific transmission direction indication by a newly defined QCL type.

In some example embodiments, the first indication may be indicative of a first frame structure for the first beam, and the apparatus 1000 may further comprise a preventing module configured to prevent from transmitting, to the terminal device, a second frame structure for the second beam. In this way, unified spectrum utilization can be designed for full duplex, SBFD, TDD and FDD via beam-specific transmission direction indication by a newly defined QCL type, and frame structure can be indicated to the terminal device in an implicit way, i.e., without explicit signaling. Therefore, overhead can be reduced.

In some example embodiments, the first indication may be indicative of a first resource and a second resource. The time domain information may comprise first time domain information for the first resource and second time domain information for the second resource, and the first time domain information and the second time domain information may be the same or different. The frequency domain information may comprise first frequency domain information for the first resource and second frequency domain information for the second resource, and the first frequency time domain information and the second frequency domain information may be the same or different. The spatial domain information may comprise first spatial domain information for the first resource and second spatial domain information for the second resource, and the first spatial domain information and the second spatial domain information may be the same or different. In this way, unified spectrum utilization can be designed for full duplex, SBFD, TDD and FDD via beam-specific transmission direction indication.

In some example embodiments, the first spatial domain information may be indicative of a beam, and the first time domain information may be indicative of a set of symbols for the beam. Here, the set of symbols may include at least one UL symbol. In this way, unified spectrum utilization can be designed for full duplex, SBFD, TDD and FDD via beam-specific transmission direction indication.

In some example embodiments, the second spatial domain information may be indicative of a beam, and the second time domain information may be indicative of a set of symbols for the beam. Here, the set of symbols may include at least one DL symbol. In this way, unified spectrum utilization can be designed for full duplex, SBFD, TDD and FDD via beam-specific transmission direction indication.

In some example embodiments, the first indication may comprise the first time domain information, the first frequency domain information, and the first spatial domain information. In this way, unified spectrum utilization can be designed for full duplex, SBFD, TDD and FDD via beam-specific transmission direction indication.

In some example embodiments, the first indication may further comprise the first power domain information. In this way, unified spectrum utilization can be designed for full duplex, SBFD, TDD and FDD via beam-specific transmission direction indication and power control parameter indication.

In some example embodiments, the first time domain information may indicate a symbol location of the one or more resources. In addition or as an alternative, the first time domain information may indicate a slot location of the one or more resources. In addition or as an alternative, the first time domain information may indicate a subframe location of the one or more resources. In this way, unified spectrum utilization can be designed for full duplex, SBFD, TDD and FDD via beam-specific transmission direction indication.

In some example embodiments, the first frequency domain information may indicate carrier information of the one or more resources. In addition or as an alternative, the first frequency domain information may indicate bandwidth part (BWP) information of the one or more resources. In addition or as an alternative, the first frequency domain information may indicate resource block (RB) information of the one or more resources. In this way, unified spectrum utilization can be designed for full duplex, SBFD, TDD and FDD via beam-specific transmission direction indication.

In some example embodiments, the first spatial domain information may indicate a beam index of the one or more resources. In addition or as an alternative, the first spatial domain information may indicate a beam set of the one or more resources. In addition or as an alternative, the first spatial domain information may indicate multiple-input multiple-output (MIMO) layer information of the one or more resources. In this way, unified spectrum utilization can be designed for full duplex, SBFD, TDD and FDD via beam-specific transmission direction indication.

In some example embodiments, the first power domain information may indicate at least one power control parameter of the first one or more resources, and the second power domain information may indicate at least one power control parameter of the second one or more resources. In this way, unified spectrum utilization can be designed for full duplex, SBFD, TDD and FDD via beam-specific transmission direction indication and power control parameter indication.

In some example embodiments, the first power domain information and the second power domain information may comprise configured maximum output power in the associated beam. In addition or as an alternative, the first power domain information and the second power domain information may comprise expected receiving power at the receiver node. In addition or as an alternative, the first power domain information and the second power domain information may comprise a pathloss compensation factor. In this way, unified spectrum utilization can be designed for full duplex, SBFD, TDD and FDD via beam-specific transmission direction indication and power control parameter indication.

In some example embodiments, the first spatial domain information of the first one or more resources for reception by the terminal device may be represented by at least one channel state information (CSI)-reference signal (RS) resource. Alternatively, the first spatial domain information of the first one or more resources for transmission by the terminal device may be represented by at least one sounding reference signal (SRS) resource. In this way, unified spectrum utilization can be designed for full duplex, SBFD, TDD and FDD via beam-specific transmission direction indication.

In this way, according to apparatus 1000, unified spectrum utilization can be designed for full duplex, SBFD, TDD and FDD via beam-specific transmission direction indication.

FIG. 11 illustrates a simplified block diagram of a device 1100 that is suitable for implementing some example embodiments of the present disclosure. The device 1100 may be provided to implement a communication device, for example, the network device 220 or the terminal device 210 as shown in FIG. 2. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 may include a transmitter 1141 for transmitting data and a receiver 1142 for receiving data. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 2 and 7-8. The embodiments of the present disclosure may also be implemented by hardware or by a combination of software and hardware.

In some example embodiments, the program 1130 may be tangibly contained in a computer-readable medium which may be included in the device 1100 (such as in the memory 1120) or other storage devices that are accessible by the device 1100. The device 1100 may load the program 1130 from the computer-readable medium to the RAM 1122 for execution. The computer-readable medium may include any types of tangible non-volatile storage, such as ROM, EPROM, a flash memory, a hard disk, CD, DVD, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 200 or 700 or 800 as described above with reference to FIGS. 2 and 7-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Through this document, the terms defined below may be referenced.
LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE target UE
UCI Uplink control information
UE User Equipment
UL Uplink
UL-SCH Uplink shared channel

What is claimed is:

1. A method comprising:
receiving, by a terminal device, a first indication of first one or more resources for transmission, wherein the first indication comprises at least three of first time domain information, first frequency domain information, first spatial domain information, or first power domain information of the first one or more resources, and wherein the first indication is indicative of a first beam, and the first beam is an uplink (UL) beam; and
receiving information indicating that a second signal associated with a second beam is quasi co-located (QCLed) with a first signal associated with the first beam with regard to a QCL type, wherein the second beam is a downlink (DL) beam, and the QCL type indicates that transmission of the first signal via the first beam and reception of the second signal via the second beam are performed simultaneously.

2. The method of claim 1, further comprising:
receiving, by the terminal device, a second indication of second one or more resources for reception, wherein the second indication comprises at least three of second time domain information, second frequency domain information, second spatial domain information, or second power domain information of the second one or more resources.

3. The method of claim 2, wherein:
the first time domain information and the second time domain information are the same or different;
the first frequency domain information and the second frequency domain information are the same or different; or
the first spatial domain information and the second spatial domain information are the same or different.

4. The method of claim 2, wherein:
the first time domain information and the second time domain information are the same;
the first frequency domain information and the second frequency domain information are the same; and
the first spatial domain information and the second spatial domain information are different.

5. The method of claim 1, wherein:
the first indication is indicative of a first resource and a second resource;
the time domain information comprises first time domain information for the first resource and second time domain information for the second resource, and the first time domain information and the second time domain information are the same or different;
the frequency domain information comprises first frequency domain information for the first resource and second frequency domain information for the second resource, and the first frequency time domain information and the second frequency domain information are the same or different; and
the spatial domain information comprises first spatial domain information for the first resource and second spatial domain information for the second resource, and the first spatial domain information and the second spatial domain information are the same or different.

6. A method comprising:
determining, at a network device, first one or more resources for a terminal device to perform transmission; and
transmitting, to the terminal device, a first indication of the first one or more resources, wherein the first indication comprises at least three of first time domain information, first frequency domain information, first spatial domain information, or first power domain information of the first one or more resources, and wherein the first indication is indicative of a first beam which is an uplink (UL) beam;
determining that reception of a first signal via the first beam and of a transmission second signal via a second beam are to be performed simultaneously, wherein the second beam is a downlink (DL) beam; and
transmitting, to the terminal device, information indicating that the second signal associated with the second beam is quasi co-located (QCLed) with the first signal associated with the first beam with regard to a QCL type, and the QCL type indicates that reception of the first signal via the first beam and transmission of the second signal via the second beam are performed simultaneously at the terminal device.

7. The method of claim 6, further comprising:
determining, at the network device, second one or more resources for the terminal device to perform reception; and
transmitting, to the terminal device, a second indication of the second one or more resources, wherein the second indication comprises at least three of second time domain information, second frequency domain information, second spatial domain information, or second power domain information of the second one or more resources.

8. The method of claim 7, wherein:
the first time domain information and the second time domain information are the same or different;
the first frequency domain information and the second frequency domain information are the same or different; or
the first spatial domain information and the second spatial domain information are the same or different.

9. The method of claim 7, wherein:
the first time domain information and the second time domain information are the same;
the first frequency domain information and the second frequency domain information are the same; and
the first spatial domain information and the second spatial domain information are different.

10. The method of claim 6, wherein:
the first indication is indicative of a first resource and a second resource;
the time domain information comprises first time domain information for the first resource and second time domain information for the second resource, and the first time domain information and the second time domain information are the same or different;
the frequency domain information comprises first frequency domain information for the first resource and second frequency domain information for the second resource, and the first frequency time domain information and the second frequency domain information are the same or different; and
the spatial domain information comprises first spatial domain information for the first resource and second spatial domain information for the second resource, and the first spatial domain information and the second spatial domain information are the same or different.

11. An apparatus comprising:
at least one processor coupled with a memory storing instructions, wherein when the instructions executed by the at least one processor, the apparatus is caused to:
receive a first indication of first one or more resources for transmission, wherein the first indication comprises at least three of first time domain information, first frequency domain information, first spatial domain information, or first power domain information of the first one or more resources, and wherein the first indication is indicative of a first beam, and the first beam is an uplink (UL) beam;
receive information indicating that a second signal associated with a second beam is quasi co-located (QCLed) with a first signal associated with the first beam with regard to a QCL type, wherein the second beam is a downlink (DL) beam, and the QCL type indicates that transmission of the first signal via the first beam and reception of the second signal via the second beam are performed simultaneously.

12. The apparatus of claim 11, wherein the apparatus is further caused to:
receive a second indication of second one or more resources for reception, wherein the second indication comprises at least three of second time domain information, second frequency domain information, second spatial domain information, or second power domain information of the second one or more resources.

13. The apparatus of claim 12, wherein:
the first time domain information and the second time domain information are the same or different;
the first frequency domain information and the second frequency domain information are the same or different; or
the first spatial domain information and the second spatial domain information are the same or different.

14. The apparatus of claim 12, wherein:
the first time domain information and the second time domain information are the same;
the first frequency domain information and the second frequency domain information are the same; and
the first spatial domain information and the second spatial domain information are different.

15. The apparatus of claim 11, wherein:
the first indication is indicative of a first resource and a second resource;
the time domain information comprises first time domain information for the first resource and second time domain information for the second resource, and the first time domain information and the second time domain information are the same or different;
the frequency domain information comprises first frequency domain information for the first resource and second frequency domain information for the second resource, and the first frequency time domain information and the second frequency domain information are the same or different; and
the spatial domain information comprises first spatial domain information for the first resource and second spatial domain information for the second resource, and the first spatial domain information and the second spatial domain information are the same or different.

16. An apparatus comprising:
at least one processor coupled with a memory storing instructions, wherein when the instructions executed by the at least one processor, the apparatus is caused to:
determine first one or more resources for a terminal device to perform transmission;
transmit, to the terminal device, a first indication of the first one or more resources, wherein the first indication comprises at least three of first time domain information, first frequency domain information, first spatial domain information, or first power domain information of the first one or more resources, and wherein the first indication is indicative of a first beam which is an uplink (UL) beam;
determine that reception of a first signal via the first beam and of a transmission second signal via a second beam are to be performed simultaneously, wherein the second beam is a downlink (DL) beam; and
transmit, to the terminal device, information indicating that the second signal associated with the second beam is quasi co-located (QCLed) with the first signal associated with the first beam with regard to a QCL type, and the QCL type indicates that reception of the first signal via the first beam and transmission of the second signal via the second beam are performed simultaneously at the terminal device.

17. The apparatus of claim 16, wherein the apparatus is further enabled to:
determine second one or more resources for the terminal device to perform reception; and
transmit, to the terminal device, a second indication of the second one or more resources, wherein the second indication comprises at least three of second time domain information, second frequency domain information, second spatial domain information, or second power domain information of the second one or more resources.

18. The apparatus of claim 17, wherein:
the first time domain information and the second time domain information are the same or different;
the first frequency domain information and the second frequency domain information are the same or different; or
the first spatial domain information and the second spatial domain information are the same or different.

19. The apparatus of claim 17, wherein:
the first time domain information and the second time domain information are the same;
the first frequency domain information and the second frequency domain information are the same; and
the first spatial domain information and the second spatial domain information are different.

20. The apparatus of claim 16, wherein:
the first indication is indicative of a first resource and a second resource;
the time domain information comprises first time domain information for the first resource and second time domain information for the second resource, and the first time domain information and the second time domain information are the same or different;
the frequency domain information comprises first frequency domain information for the first resource and second frequency domain information for the second resource, and the first frequency time domain information and the second frequency domain information are the same or different; and
the spatial domain information comprises first spatial domain information for the first resource and second spatial domain information for the second resource, and the first spatial domain information and the second spatial domain information are the same or different.
